(19) United States
(12) Patent Application Publication
(10) Pub. No.: US 2012/0201114 A1
(43) Pub. Date: Aug. 9, 2012

(54) OPTICAL PICKUP, OPTICAL RECORDING/REPRODUCING DEVICE, COMPUTER, OPTICAL DISK RECORDER, AND MINUTE SPOT FORMING METHOD

(76) Inventor: Kousei Sano, Osaka (JP)

(21) Appl. No.: 13/502,600

(22) PCT Filed: Oct. 20, 2010
(86) PCT No.: PCT/JP2010/006226

§ 371 Date: Apr. 18, 2012

(30) Foreign Application Priority Data
Oct. 21, 2009 (JP) 2009-242021

(51) Int. Cl. G11B 7/135; F21V 9/14

(52) U.S. Cl. 369/112.16; 362/19; G9B/7.112

(57) ABSTRACT

An optical pickup, an optical recording/reproducing device, a computer, an optical disk recorder, and a minute spot forming method that can enable light propagation with a high transmittance and can form a minute spot. The optical pickup includes a wavelength plate (202) that converts the polarization state of the light beam emitted from a semiconductor laser (101) and an objective lens optical system (105) that converges the light beam whose polarization state has been converted with a numerical aperture greater than 1. The wavelength plate (202) generates a light beam having a polarization state that differs depending on location. The polarization distribution of the light beam generated by the wavelength plate (202) is axially symmetric with respect to the optical axis of the light beam as an axis of symmetry. A light ray on the light axis is a circularly polarized light. Part of a light ray other than the light ray on the optical axis is an elliptically polarized light with an ellipticity of less than 1. An angle formed by a long axis of an ellipse and a circumferential direction of a circle centered on the light axis in each elliptically polarized light is less than ±45 degrees.

### TECHNICAL FIELD

The present invention relates to an optical pickup that records or reproduces information on or from an optical recording medium such as an optical disk or an optical card by irradiating the optical recording medium with light, and also to an optical recording/reproducing device using the optical pickup, a computer using the optical recording/reproducing device, an optical disk recorder using the optical recording/reproducing device, and a minute spot forming method for forming a minute spot.

### BACKGROUND ART

Optical disks such as CD, DVD, or BD (Blu-ray disks) have been widely used as an optical recording medium for recording various types of information such as images and sound. In an optical recording/reproducing device using such optical recording medium, since recording or reproducing of information is performed by irradiating the optical recording medium with light, the recording density of information depends on the size of the light spot converged on the optical recording medium. Therefore, the capacity of the optical recording medium can be increased by decreasing the size of the light spot obtained by irradiation with the optical pickup. The size of the light spot is proportional to the numerical aperture of an objective lens and inversely proportional to the wavelength of the radiated light. Therefore, the wavelength of the light used may be further shortened or the numerical aperture of the objective lens may be further increased in order to form a light spot of smaller size.

However, in the optical recording/reproducing devices that have heretofore been put to practical use, the distance between the optical recording medium and the objective lens is sufficiently large in comparison with the light wavelength. Further, when the numerical aperture of the objective lens is greater than 1, the light incident of the objective lens is completely reflected by the lens outgoing surface. As a result, the recording density of the optical recording medium is impossible to increase.

Accordingly, a near-field optical recording/reproducing method using a SIL (solid immersion lens) has been disclosed as an optical recording/reproducing method for the case in which the numerical aperture (NA) of the objective lens is greater than 1. The numerical aperture NA is defined as NA=n·sin θ, where n stands for a refractive index of the medium and θ stands for a maximum angle formed by the light beam with the optical axis in the medium. Usually, when the numerical aperture is greater than 1, the light falls on the objective lens at an angle equal to or greater than a critical angle. The light in a region equal to or greater than the critical angle undergoes complete reflection on the outgoing end surface of the objective lens. This completely reflected light oozes out as evanescent light from the outgoing end surface in the vicinity of the outgoing end surface. In the near-field optical recording/reproducing method, the propagation of this evanescent light is enabled. Therefore, the clearance (air gap) between the outgoing end surface of the objective lens and the optical recording medium surface is maintained less than the attenuation distance of the evanescent light and the light within a range in which the numerical aperture is greater than 1 is transmitted from the objective lens to the optical recording medium.

However, the transmittance of light passing through the air gap changes depending on the polarization direction, angle of incidence, air gap size, and refractive index of each substance. In particular, where the angle of incidence (angle formed by the incident light with the normal to the surface of the optical recording medium) increases, the dependence on polarization also increases. Up to a certain angle, the transmittance of the P-polarized light is higher than that of the S-polarized light, but when the specific angle is exceeded, the transmittance of the S-polarized light becomes larger than that of the P-polarized light.

FIG. 26 is a plot diagram illustrating the transmittance of P-polarized light and S-polarized light versus NA in the case where light with a wavelength of 650 nm propagates in an air gap with a clearance of 50 nm between substances with a refractive index of 1.9. Under such conditions, before the NA becomes close to 1.2, the transmittance Tp of the P-polarized light is higher than the transmittance Ts of the S-polarized light, and where the NA becomes close to or higher than 1.2, the transmittance Ts of the S-polarized light becomes higher than the transmittance Tp of the P-polarized light

With consideration for such a characteristic, in the conventional optical head device, the intensity distribution of a semiconductor laser is made elliptic, the long axis direction of the intensity distribution is selected along the direction of P polarization and the short axis direction is selected along the direction of S polarization in order to average the quantity of light determined by polarization direction when the incident light is a linearly polarized light in the case where the NA is equal to or greater than 1.2 (see, for example, Patent Literature 1).

FIG. 27 illustrates the configuration of the conventional optical head device described in Patent Literature 1.

In FIG. 27, a light beam 102 emitted from a semiconductor laser 101 is made a substantially parallel light by a converging lens 103, passes through a beam splitter 104, and falls on an objective lens optical system 105. In the present description, the convergence position means a beam waist position of the converged light. The objective lens optical system 105 is constituted by a lens 105a and a SIL (solid immersion lens) 105b. An air gap present between the outgoing end surface of the SIL 105b and the surface of the optical recording medium 106 facing the outgoing end surface is made shorter than the evanescent attenuation length and light propagation is performed by the evanescent light. In this case, the light beam 102 emitted from the semiconductor layer 101 has an elliptical intensity distribution, the decrease in intensity in the long axis direction is small even with a wide angle of incidence, and the decrease in intensity in the short axis direction is large even with a narrow angle of incidence. In the conventional example, the polarization direction is determined such that the long axis direction corresponds to P polarization and the short axis direction corresponds to S polarization.

Where the refractive index of the optical disk, which is an optical recording medium, is denoted by n and sin θ in NA=n·sin θ is greater than 0.85, the angle θ formed by the surrounding light beam with the optical axis is equal to or greater than 60 degrees. A phenomenon of the diameter of the converged spot changing according to the polarization direction of the incident light is observed when the angle θ increases. Thus, in the S-polarized light, which is the polarized light perpendicular to the plane of incidence, the directions of the electric field vectors E match even though the angle θ is large, as shown in FIG. 28A and FIG. 28B. Therefore, the effect attained by increasing the NA is directly demonstrated and the spot diameter decreases in proportion to the NA ratio. Meanwhile, in the P-polarized light, which is the polarized light parallel to the plane of incidence, the direction of the electric field vector E changes depending on the angle θ and the directions of electric field vectors E do not match, as shown in FIG. 29A and FIG. 29B. Therefore, the effect attained by increasing the NA is eliminated and the spot diameter does not decrease in proportion to the NA. For this reason, if sine is increased in a linearly polarized light beam, the spot diameter increases in the direction corresponding to P polarization and an elliptical spot is obtained.

Considering a specific example, in the conventional optical head device in which information is recorded on or reproduced from a BD, when NA=0.85 and n=1.54, the angle θ is 33.5 degrees. The full width at half maximum in the P-polarization direction of the spot of linearly polarized light in this case merely increases by 8% with respect to the full width at half maximum in the S-polarization direction. Meanwhile, in a SIL optical head device, when NA=1.84 and n=2.068, the angle θ is 62.8 degrees. In this case, the full width at half maximum in the P-polarization direction of the spot of linearly polarized light in this case increases by 31% with respect to the full width at half maximum in the S-polarization direction. The ratio of the full width at half maximum in the P-polarization direction and the full width at half maximum in the S-polarization direction exceeds 1.2 at an angle θ of about 50 degrees. In a circularly polarized light, the average value of P-polarized light and S-polarized light becomes almost the spot size. Therefore, where θ exceeds 50 degrees, the spot size of the circularly polarized light increases by about 10% with respect to the NA-recalculated ideal value.

To resolve this problem, it has been suggested to form a spot with a radially polarized light beam in which polarization is aligned in the radial direction (see, for example, Non-Patent Literature 1). FIG. 30 shows an example of a light beam in which polarization is aligned in the radial direction. In FIG. 30, the energy of light in the convergence point is represented separately by an Itrans. component perpendicular to the optical axis and an Ilong. component parallel to the optical axis. In the radially polarized light beam, where the angle θ is small, the Ilong. component becomes small and the spot assumes a donut shape with a dark central portion, but where the angle θ is brought close to 90 degrees and a spot is formed such that the Ilong. component, which is parallel to the optical axis, becomes the main component, the spot diameter can be decreased.

However, the problem associated with the aforementioned conventional configuration is that since the intensity is changed only by the direction of the linearly polarized light, the difference in quantity of light caused by the direction is reduced, but the transmission efficiency essentially does not increase and the light utilization efficiency decreases. Yet another problem is that since the ratio of P-polarized light and S-polarized light is constant depending on the direction, the aforementioned conventional configuration cannot be applied to optical systems using circular polarization.

Further, even if the polarization is aligned in the radial direction, a spot in which the Ilong. component parallel to the optical axis is the main component cannot be formed unless the light beam falls at an angle θ that is extremely close to 90 degrees, that is such, that sin θ essentially becomes 1. The resultant problem is that the optical system is difficult to configure.

### CITATION LIST

### Patent Literature

Patent Literature 1: Japanese Patent Application Laid-open No. H11-213435

### Non-patent Literature

Non-patent Literature 1: Tzu-Hsiang LAN and Chung-Hao TIEN, “Study on Focusing Mechanism of Radial Polarization with Immersion Objective”, Japanese Journal of Applied Physics, Vol. 47, No. 7, 2008, pp. 5806-5808, Jul. 18, 2008

### SUMMARY OF INVENTION

It is an object of the present invention to provide an optical pickup, an optical recording/reproducing device, a computer, an optical disk recorder, and a minute spot forming method that can enable light propagation with a high transmittance and can form a minute spot.

The optical pickup according to the first aspect of the present invention records or reproduces information on or from an optical recording medium by using a light beam emitted from a light source, the optical pickup including: a polarization converting element that converts a polarization state of the light beam emitted from the light source; and an objective lens optical system that converges the light beam, whose polarization state has been converted by the polarization converting element, with a numerical aperture greater than 1, wherein the polarization converting element generates a light beam having a polarization state that differs depending on location; a polarization distribution of the light beam generated by the polarization converting element is axially symmetric with respect to an optical axis of the light beam as an axis of symmetry; a light ray on the light axis is a circularly polarized light; part of a light ray other than the light ray on the optical axis is an elliptically polarized light with an ellipticity of less than 1; and an angle formed by a long axis of an ellipse and a circumferential direction of a circle centered on the light axis in each elliptically polarized light is less than ±45 degrees.

With such a configuration, the polarization converting element converts the polarization state of the light beam emitted from the light source, and the objective lens optical system converges the light beam, which has a polarization state converted by the polarization converting element, with a numerical aperture greater than 1. The polarization converting element generates a light beam having a polarization state that differs depending on location. The polarization distribution of the light beam generated by the polarization converting element is axially symmetric with respect to the optical axis of the light beam as an axis of symmetry, a light ray on the light axis is a circularly polarized light and part of a light ray other than the light ray on the optical axis is an elliptically polarized light with an ellipticity of less than 1. The angle formed by a long axis of an ellipse and a circumferential direction of a circle centered on the light axis in each elliptically polarized light is less than ±45 degrees.

In accordance with the present invention, in the light ray at a position far from the optical axis, the S-polarized component is larger than the P-polarized component and the light can be caused to propagate with a high transmittance. Since the S-polarized component increases also when a spot is formed, the component with aligned directions of electric field vectors increases and a minute spot can be formed.

The objects, features, and merits of the present invention will be made more apparent by the detailed explanation presented hereinbelow and the appended drawings.

### BRIEF DESCRIPTION OF DRAWINGS

FIG. 1 illustrates the configuration of an optical pickup in Embodiment 1 of the present invention.

FIG. 2A is a schematic drawing illustrating an example of polarization distribution in a cross section of the light beam outgoing from the wavelength plate in Embodiment 1 of the present invention, and FIG. 2B is a schematic drawing illustrating an example of distribution of the phase difference and the direction of the principal axis of birefringence in the wavelength plate in Embodiment 1 of the present invention.

FIG. 3A is a schematic drawing illustrating an example of a Poincare sphere representing light polarization states, and FIG. 3B is a schematic diagram illustrating the conversion from the linear polarization to the elliptical polarization on the Poincare sphere.

FIG. 4 shows the distribution of the azimuth of the principal axis of birefringence in the case of f(r)=1−0.5r by contour lines in Embodiment 1 of the present invention.

FIG. 5 shows the distribution of the phase difference of birefringence in the case of f(r)=1−0.5r by contour lines in Embodiment 1 of the present invention.

FIG. 6 is a schematic diagram showing the polarization distribution of the light beam after it has passed through the wavelength plate having the characteristics shown in FIG. 4 and FIG. 5 in Embodiment 1 of the present invention.

FIG. 7 shows the distribution of the azimuth of the principal axis of birefringence in the case of f(r)=1−0.9r by contour lines in Embodiment 1 of the present invention.

FIG. 8 shows the distribution of the phase difference of birefringence in the case of f(r)=1−0.9r by contour lines in Embodiment 1 of the present invention.

FIG. 9 is a schematic diagram showing the polarization distribution of the light beam after it has passed through the wavelength plate having the characteristics shown in FIG. 7 and FIG. 8.

FIG. 10A shows a cross-sectional profile of a spot in the case where the ellipticity f(r) is taken as 1−0.5r, and FIG. 10B shows the conventional cross-sectional profile of a spot in Embodiment 1 of the present invention.

FIG. 11 is a plot diagram illustrating the transmittance of various types of polarized light obtained when the light with a wavelength of 405 nm passes through an air gap with a clearance of 30 nm between the SIL and optical recording medium with a refractive index 2.068.

FIG. 12 shows an example of the immersion-type objective lens optical system in Embodiment 1 of the copresent invention.

FIG. 13A is a plot diagram illustrating an example in which the dependence of the ellipticity on the distance from the optical axis is represented by a first-order function in Embodiment 1 of the present invention, FIG. 13B is a plot diagram illustrating an example in which the dependence of the ellipticity on the distance from the optical axis is represented by a second-order function in Embodiment 1 of the present invention, FIG. 13C is a plot diagram illustrating an example in which the ellipticity is constant from the optical axis to a predetermined radial position and represented by a first-order function of the distance from the optical axis after the predetermined radial position in Embodiment 1 of the present invention, and FIG. 13D is a plot diagram illustrating an example in which the dependence of the ellipticity on the distance from the optical axis is represented by a step function in Embodiment 1 of the present invention.

FIG. 14A shows an ellipticity that changes according to a step function, FIG. 14B shows an ellipticity in the case of a full-plane circularly polarized light, and FIG. 14C shows an ellipticity that changes according to a first-order function.

FIG. 15A illustrates the relationship between the full width at half maximum (FWHM) of the spot and the normalized radius with respect to the ellipticity presented in FIGS. 14A to 14C, and FIG. 15B illustrates the relationship between the Strehl intensity of the spot and the normalized radius with respect to the ellipticity presented in FIGS. 14A to 14C.

FIG. 16 represents by contour lines the distribution of the azimuth of the principal axis of birefringence of the wavelength plate in the case where the ellipticity decreases at a position with a normalized radius r of 0.7.

FIG. 17 represents by contour lines the distribution of the phase difference of birefringence of the wavelength plate in the case where the ellipticity decreases at a position with a normalized radius r of 0.7.

FIG. 18 is a schematic diagram illustrating another example of polarization distribution in a cross section of the light beam in Embodiment 1 of the present invention.

FIG. 19 is a flowchart illustrating an example of the sequence of the minute spot forming method in Embodiment 1 of the present invention.

FIG. 20 illustrates the configuration of the optical pickup in Embodiment 2 of the present invention.

FIG. 21 is a plot diagram illustrating the transmittance distribution of the transmission filter in Embodiment 2 of the present invention.

FIG. 22 shows the configuration of the optical pickup in Embodiment 3 of the present invention.

FIG. 23 shows a schematic configuration of the optical recording/reproducing device in Embodiment 4 of the present invention.

FIG. 24 is a schematic perspective view illustrating the entire configuration of the computer in Embodiment 5 of the present invention.

FIG. 25 is a schematic perspective view illustrating the entire configuration of the optical disk recorder in Embodiment 6 of the present invention.

FIG. 26 is a plot diagram illustrating the transmittance of P-polarized light and S-polarized light versus NA in the case where light with a wavelength of 650 nm propagates in an air gap with a clearance of 50 nm between substances with a refractive index of 1.9.

FIG. 27 illustrates the configuration of the conventional optical head device.

FIG. 28A is a schematic drawing illustrating the direction of the electric field vector of S-polarized wave component in the case where the linearly polarized light is converged, and FIG. 28B is a side surface view illustrating the direction of electric field vector of S-polarized wave component near the convergence point.

FIG. 29A is a schematic drawing illustrating the direction of the electric field vector of P-polarized wave component in the case where the linearly polarized light is converged, and FIG. 29B is a side surface view illustrating the direction of electric field vector of P-polarized wave component near the convergence point.

FIG. 30A is a schematic diagram illustrating the direction of the intensity vector of light in the case where a radially polarized light beam is converged, and FIG. 30B is a side surface view illustrating the direction of the intensity vector of radially polarized light near the convergence point.

### DESCRIPTION OF EMBODIMENTS

Embodiments of the present invention will be described below in greater detail with reference to the appended drawings. The below-described embodiments are examples specifically illustrating the present invention and are not intended to limit the technical scope of the present invention.

### Embodiment 1

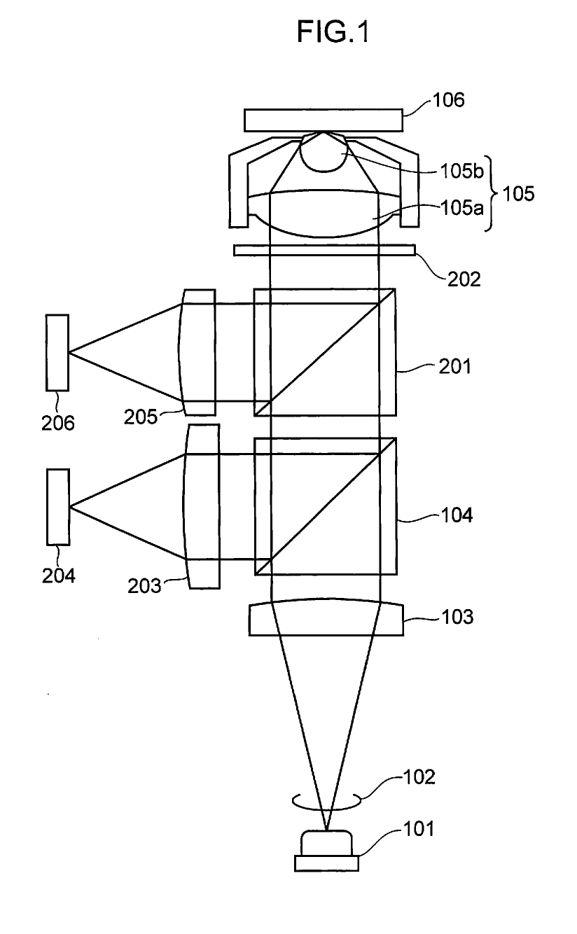

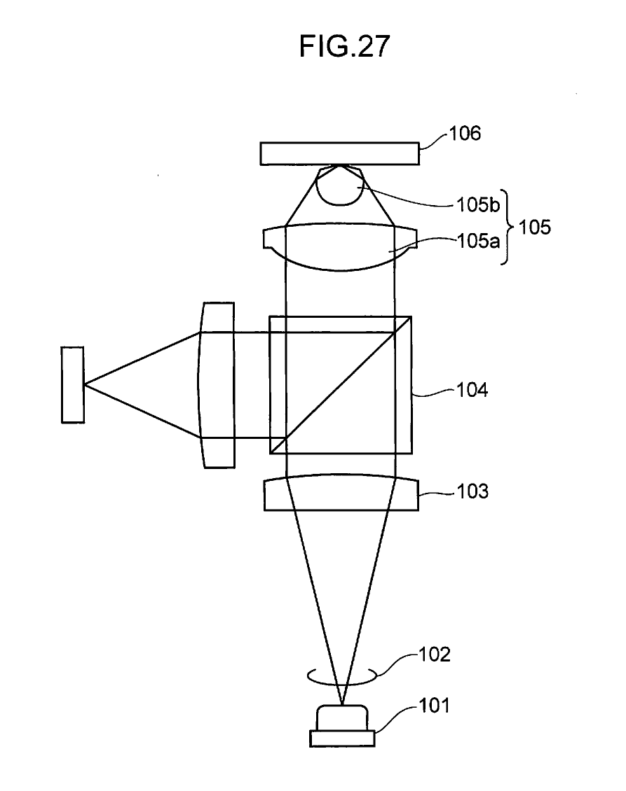

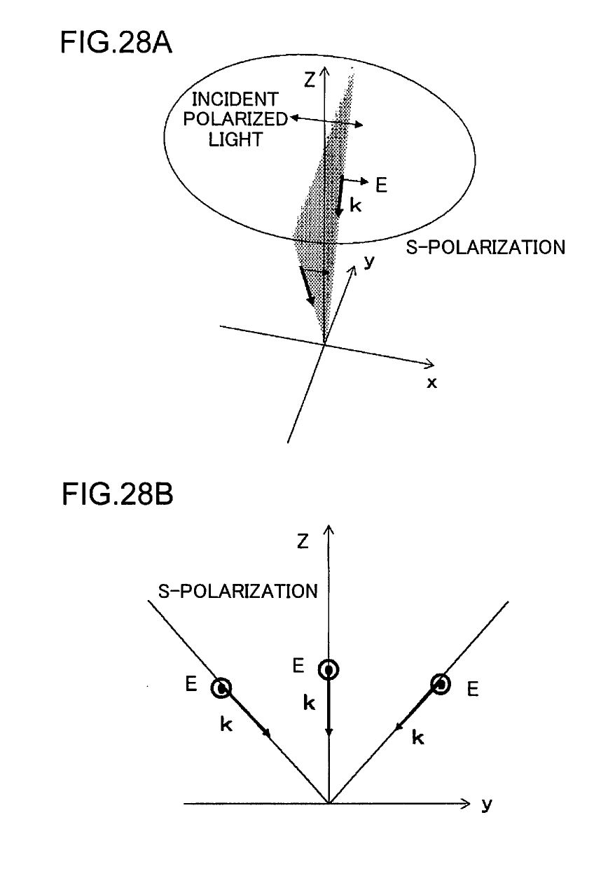

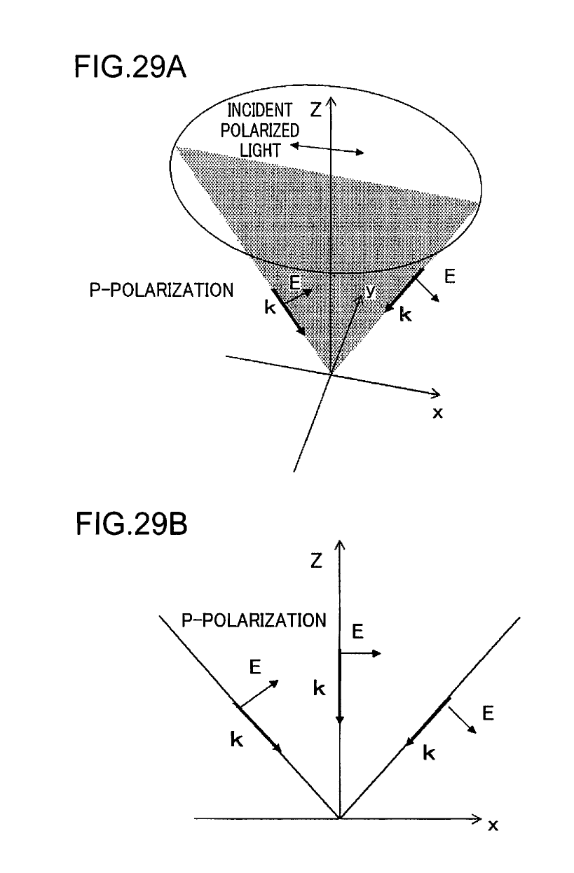

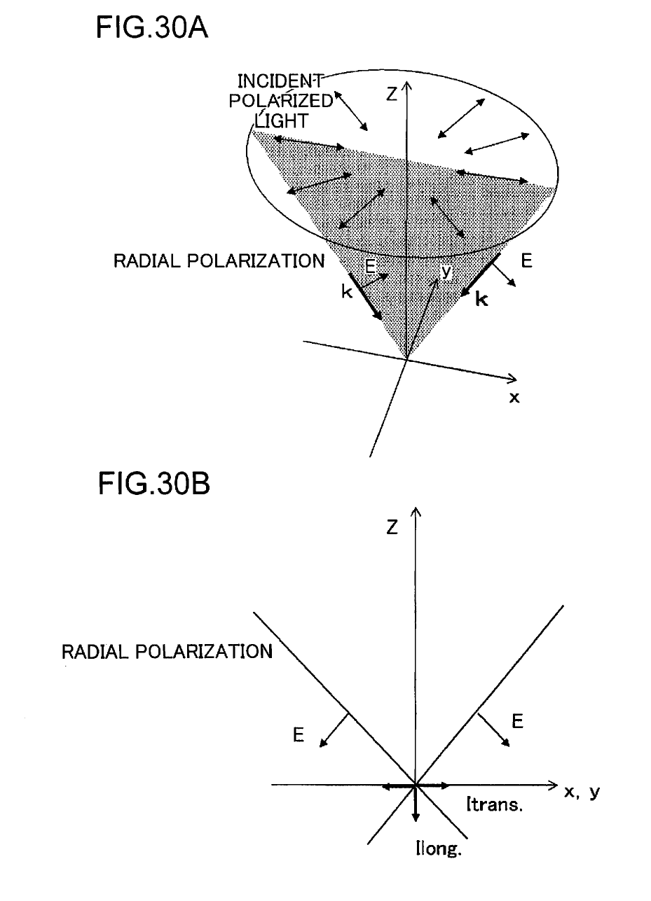

FIG. 1 illustrates the configuration of an optical pickup in Embodiment 1 of the present invention. In FIG. 1, the constituent elements identical to those shown in FIG. 27 are assigned with same reference numerals.

In FIG. 1, the optical pickup is provided with a semiconductor layer (light source) 101, a converging lens 103, beam splitters 104, 201, a wavelength plate (polarization converting element) 202, an objective lens optical system 105, a detection lens 203, a photodetector 204, a detection lens 205, and a photodetector 206.

The semiconductor layer 101 emits a linearly polarized light beam 102. The light beam 102 is converted into a substantially parallel light by the converging lens 103, passes through the beam splitters 104 and 201, and falls on the wavelength plate 202 which is a polarization converting element. The wavelength plate 202 converts the polarization state of the light beam emitted from the semiconductor layer 101. The wavelength plate 202 has a polarization distribution that is axially symmetrical with respect to the optical axis, which is the center of the light beam, and generates a light beam having a polarization state that differs depending on a light ray position. The light beam 102 that has passed through the wavelength plate 202 falls on the objective lens optical system 105.

The objective lens optical system 105 converges the light beam, which has a polarization state converted by the wavelength plate 202, with a numerical aperture greater than 1. The objective lens optical system 105 is constituted by a lens 105a and a SIL (solid immersion lens) 105b. An air gap present between the outgoing end surface of the SIL 105b and the surface of the optical recording medium 106 opposite thereto is shorter than an evanescent attenuation length, which is the distance shorter than the wavelength of the light beam 102. As a result, light propagation by the evanescent light is performed. The light beam reflected and diffracted by the optical recording medium 106 is again converted into a substantially parallel light by the objective lens optical system 105 and passes through the wavelength plate 202. Then, some light is reflected by the beam splitters 201 and 104.

The light beam reflected by the beam splitter 104 is converted by the detection lens 203 into converged light which is received by the photodetector 204. The detection lens 203 imparts astigmatism simultaneously with conversion into the converged light. The light detector 204 has four split light-receiving sections (not shown in the figure), and a focus signal is detected by an astigmatism method. Further, a tracking signal is detected by a push-pull method. The photodetector 204 generates a RF signal from a sum signal of the received light quantities. The light beam reflected by the beam splitter 201 is converted by the detection lens 205 into converged light which is received by the photodetector 206. The photodetector 206 generates a gap signal for detecting the clearance of the air gap between the SIL 105b and the optical recording medium 106.

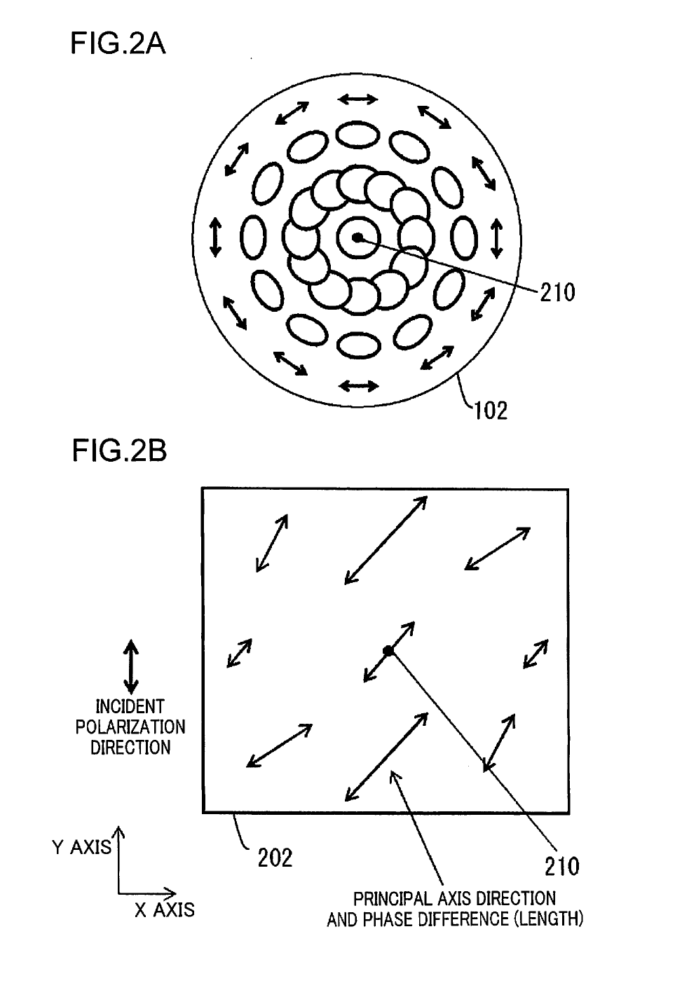

FIG. 2A is a schematic drawing illustrating an example of polarization distribution in a cross section of the light beam 102 outgoing from the wavelength plate 202. FIG. 2B is a schematic drawing illustrating an example of the distribution of phase difference and direction of the principal axis of birefringence in the wavelength plate 202. The light beam 102 is a circularly polarized light at the optical axis 210, which is the center, becomes an elliptically polarized light with increasing distance from the optical axis 210, and becomes a linearly polarized light on the outermost circumference. The long axis of each elliptically polarized light is in the circumferential direction of a circle centered on the optical axis 210. An example of the distribution of phase difference and direction of the principal axis of birefringence in the wavelength plate 202 that creates such polarization distribution is shown schematically in FIG. 2B.

As shown in FIG. 2B, the polarization direction (oscillation direction of the electric field vector) of the incident light, which is a linearly polarized light, is taken as an Y axis direction. Since the light is converted into the circularly polarized light at the optical axis 210, the direction of the principal axis of birefringence is at an angle of 45 degrees to the X axis and the phase difference may be made 90 degrees. With the increasing distance from the optical axis 210, which is a point of origin, of points on the X axis, an elliptically polarized light close to the polarization direction of the incident light is obtained. Therefore, as the direction of the principal axis of birefringence is maintained at 45 degrees in each point on the X axis, the phase difference decreases from 90 degrees and approaches 0 degrees with the increasing distance from the optical axis 210. In FIG. 2B, the direction of the principal axis is shown by the direction of arrows, and the length of the arrows represents the phase difference. With the increasing distance from the optical axis 210, which is a point of origin, of points on the Y axis, an elliptically polarized light is obtained that has a long axis oriented in the direction orthogonal to the polarization direction of the incident light. Therefore, as the direction of the principal axis of birefringence is maintained at 45 degrees in each point on the Y axis, the phase difference increases from 90 degrees and approaches 180 degrees with the increasing distance from the optical axis 210.

In a first quadrant in which both the X axis and the Y axis are positive and in a third quadrant in which both the X axis and the Y axis are negative, the direction of the long axis of the elliptically polarized light is downward and to the right, and the direction of the principal axis of birefringence decreases to below 45 degrees for converting the linearly polarized light in the Y direction to the elliptically polarized light in which the direction of the long axis is downward and to the right. The necessary phase difference is determined according to the position of each point. In a second quadrant in which the X axis is negative and the Y axis is positive and in a fourth quadrant in which the X axis is positive and the Y axis is negative, the direction of the long axis of the elliptically polarized light is upward and to the right. The direction of the principal axis of birefringence increases to above 45 degrees for converting the linearly polarized light in the Y direction to the elliptically polarized light in which the direction of the long axis is upward and to the right. The necessary phase difference is determined according to the position of each point.

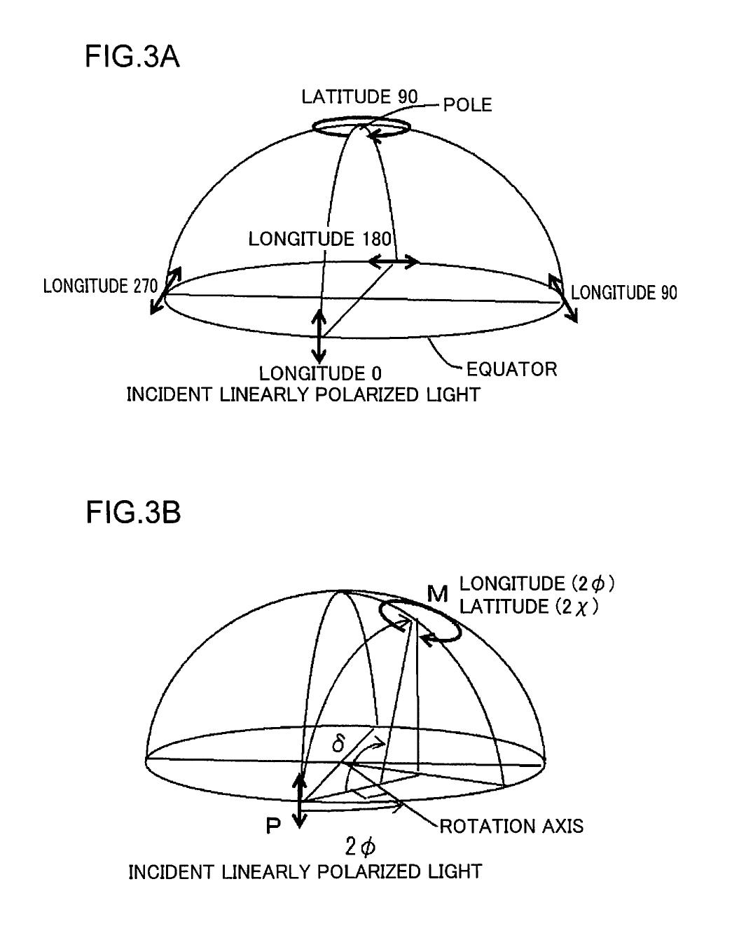

A specific method for obtaining the target polarized light will be described below in greater detail. FIG. 3A is a schematic drawing illustrating an example of a Poincare sphere representing light polarization states. In FIG. 3A only the upper half of the sphere is shown. The Poincare sphere has the following specific features (1) to (5).

(1) All linear polarization states lie on the equator (ellipticity is 0). (2) The north pole and south pole represent circularly polarized light (ellipticity is 1). (3) Elliptically polarized states are represented everywhere outside the equator and the north and south poles. (4) An angle of half the longitude from the reference point corresponds to an azimuth of the linearly or elliptically polarized light and the same longitude represents polarization with the same azimuth. (5) The north hemisphere represents right polarization, and the south hemisphere represents left polarization. A point on the Poincare sphere represents any polarization state, and any polarization state can be represented on the sphere.

In FIG. 3A, the direction of linearly polarized light with a longitude of 0 degrees which serves as a reference is defined as being parallel to a meridian. The operation of creating a certain other polarization state from the incident polarization corresponds to the operation of moving a point corresponding to the incident polarized light to a certain other point on the surface of the Poincare sphere.

A method in which a linear polarization with a latitude of 0 degrees and a longitude of 0 degrees is taken as a polarization state of the incident light and the polarization state of the light that has passed through a wavelength plate with an azimuth Φ of the principal axis of birefringence and a phase difference δ is obtained on the Poincare sphere will be explained below with reference to FIG. 3B. FIG. 3B is a schematic diagram illustrating the conversion from the linear polarization to the elliptical polarization on the Poincare sphere. The point with a latitude of 0 degrees and a longitude of 0 degrees that represents the polarization of the incident light is taken as point P. A line is drawn in an equator plane that passes through the center of the Poincare sphere and forms an angle 2φ with the line connecting the center with the point P. This line is taken as a rotation axis, and a point obtained by rotating the point P through the angle δ is taken as a point M. Where the longitude of the point M is taken as 2Φ, the azimuth of the long axis of the elliptically polarized light will be Φ. Where the longitude of the point M is taken as 2x, the ellipticity is tan⁻¹(x).

Conversely, the abovementioned relationship may be used in reverse to obtain the characteristics φ and δ of the wavelength plate for obtaining the polarization state which is wished to be determined, and the result can be uniquely obtained on the basis of the following Eq. (1) and Eq. (2).

$$\begin{matrix}[ Eq . 1 ] & \\ tan 2 φ = - \frac{cos 2 χ \cdot cos 2 Φ - 1}{sin 2 Φ} & ( 1 ) \\ [ Eq . 2 ] & \\ cos δ = 1 - \sqrt{\frac{1 + {cos}^{2} 2 χ - 2 cos 2 χ \cdot cos 2 Φ}{{sin}^{2} 2 φ}} & ( 2 )\end{matrix}$$

Where a value obtained by normalizing the distance of each point of an optical line of the light beam from the optical axis by the radius of the light beam is taken as a normalized radius r and the angle formed with the positive direction of the X axis is denoted by θ, the polarization state that is wished to be obtained is typically represented as follows.

Ellipticity=f(r) (f(0)=1).

Azimuth of long axis=θ+π/2.

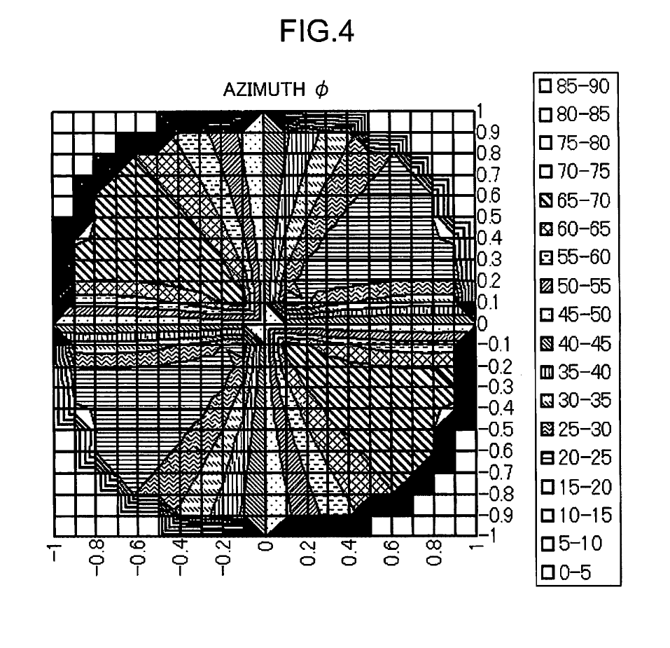

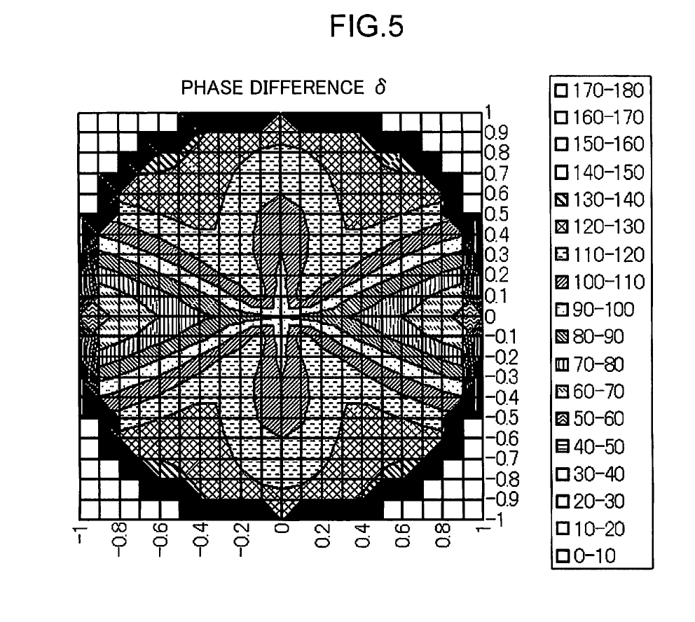

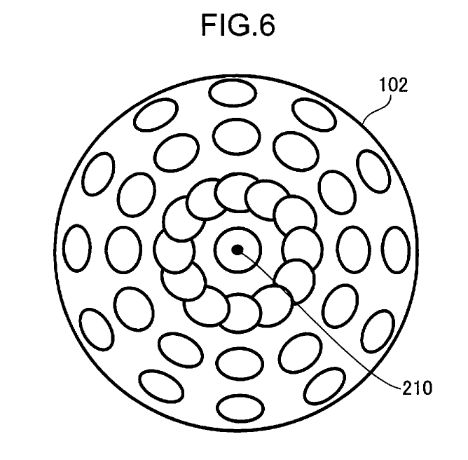

FIG. 4 to FIG. 6 show examples of distribution of the azimuth φ and phase difference δ of the wavelength plate obtained when f(r)=1−0.5r. In FIG. 4, the distribution of the azimuth of the principal axis of birefringence in the case of f(r)=1−0.5r is shown by contour lines. In FIG. 5, the distribution of the phase difference of birefringence in the case of f(r)=1−0.5r is shown by contour lines. FIG. 6 is a schematic diagram showing the polarization distribution of the light beam after it has passed through the wavelength plate having the characteristics shown in FIG. 4 and FIG. 5.

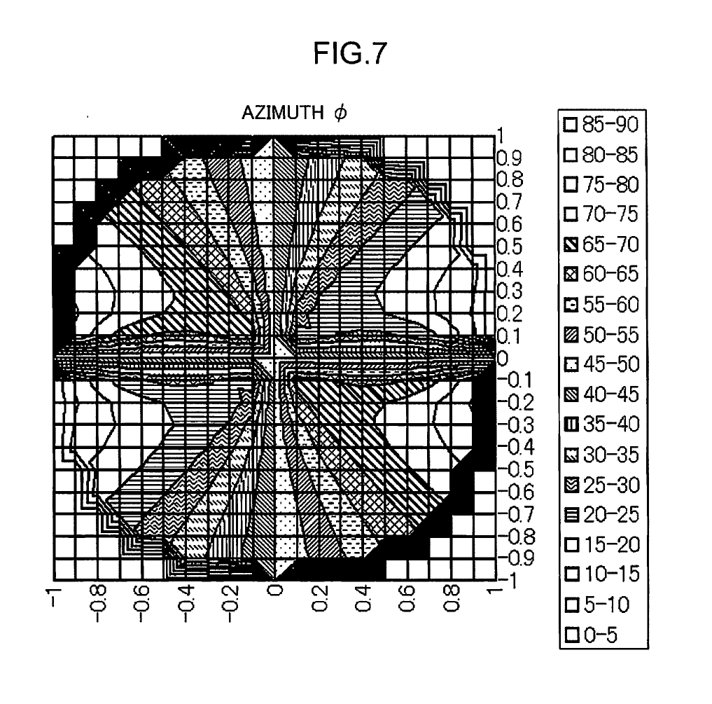

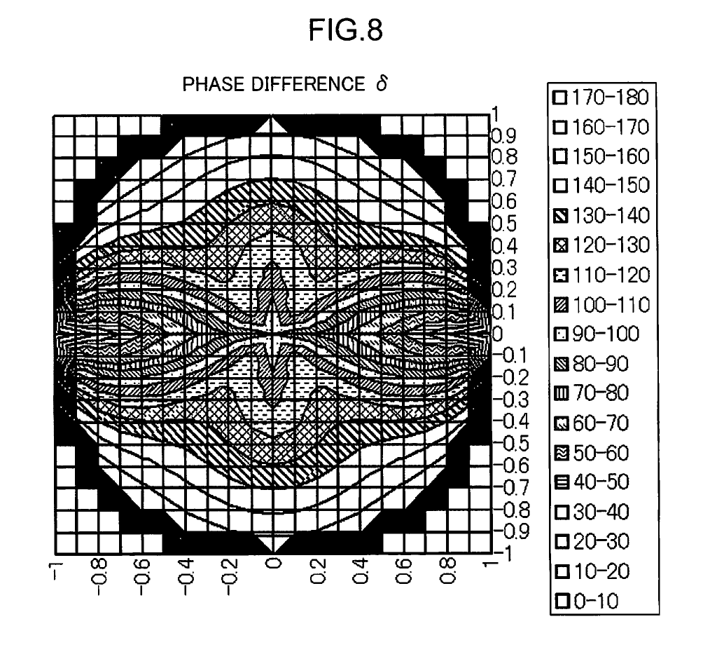

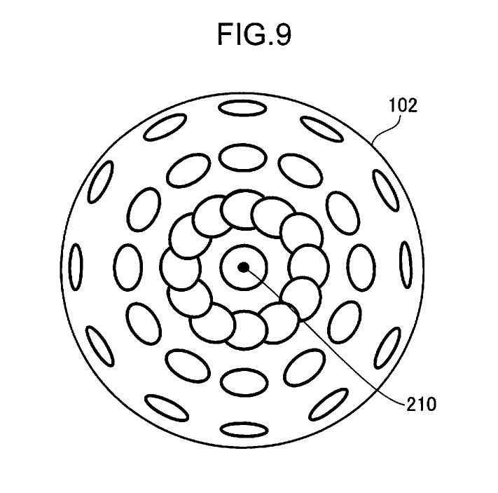

FIG. 7 to FIG. 9 show examples of distribution of the azimuth φ and phase difference δ of the wavelength plate obtained when f(r)=1−0.9r. In FIG. 7, the distribution of the azimuth of the principal axis of birefringence in the case of f(r)=1−0.9r is shown by contour lines. In FIG. 8, the distribution of the phase difference of birefringence in the case of f(r)=1−0.9r is shown by contour lines. FIG. 9 is a schematic diagram showing the polarization distribution of the light beam after it has passed through the wavelength plate having the characteristics shown in FIG. 7 and FIG. 8.

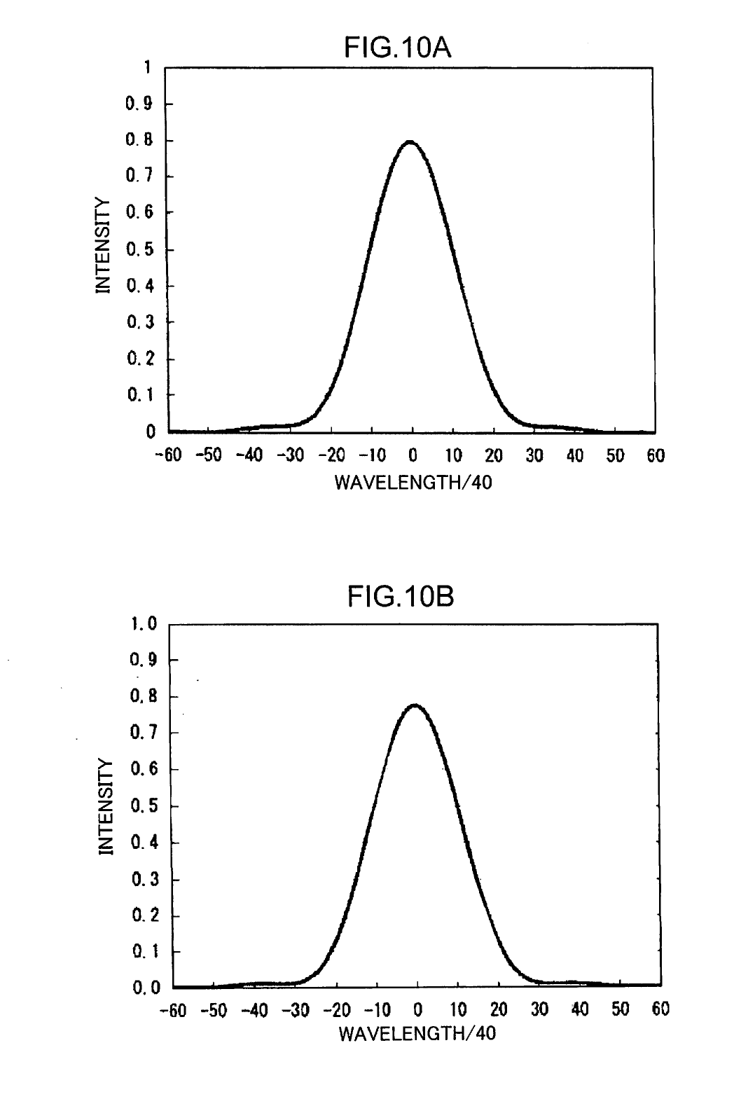

FIG. 10A shows a cross-sectional profile of a spot in the case where the ellipticity f(r) is taken as 1−0.5r in Embodiment 1 of the present invention. FIG. 10B shows the conventional cross-sectional profile of a spot. FIG. 10A shows a cross-sectional profile of a spot obtained when the refractive indexes n of the SIL and optical recording medium are both 2.068, NA is 1.84, the wavelength of the light beam is 405 nm, a gap spacing is 0 μm, and ellipticity f(r) is 1=0.5r. FIG. 10B is a cross-sectional profile of a spot obtained in the case of fully circularly polarized light shown herein as a conventional example.

Conducting comparison by the full width at half maximum (FWHM), the full width at half maximum in the case of the conventional circularly polarized light is 0.126 μm, whereas the full width at half maximum in the present embodiment is 0.122 μm. It is clear that the beam diameter is decreased by about 3% and the effective NA is increased. The Strehl intensity, which is the amount of light in the spot center, is also increased by comparison with the conventional configuration. Thus, the Strehl intensity in the case of the conventional fully circularly polarized light is 0.776, whereas the Strehl intensity in the present embodiment is 0.796, and the effect of augmenting the component with aligned directions of electric field vectors in the light ray with a large angle of incidence can be also confirmed from the standpoint of the Strehl intensity. Further, the conventional circular polarization ratio is 0.968, whereas the circular polarization ratio in the present embodiment is 1.00. When light beams with linear polarization fall under the same conditions, the full width at half maximum of the spot on the side where the S-polarized light falls decreases to 0.111 μm, whereas the full width at half maximum of the spot on the side where the P-polarized light falls becomes 0.145 μm and rather increases.

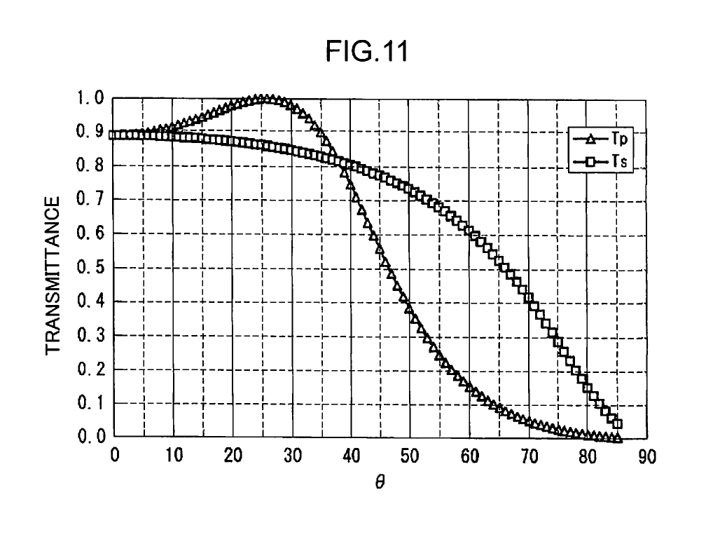

FIG. 11 is a plot diagram illustrating the transmittance of various types of polarized light obtained when the light with a wavelength of 405 nm passes through an air gap with a clearance of 30 nm between the SIL and optical recording medium with a refractive index 2.068. As shown in FIG. 11, where the angle θ of incidence is large, the transmittance Ts of the S-polarized light is higher than the transmittance Tp of the P-polarized light. With the light beam having the polarization distribution of the present embodiment, the S-polarized light component in the light ray with a large angle of incidence is larger than the P-polarized light component. Therefore, the polarization of the present embodiment is also advantageous in comparison with the conventional fully circular polarization from the standpoint of transmittance obtained when the light passes through an air gap.

The wavelength plate 202 such as shown in the present embodiment is difficult to produce by cutting out from a birefringent crystal, but the direction of the principal axis of birefringence can be created with a fine structure in a photonic crystal or the like. Therefore, the wavelength plate 202 can be produced in a shape with any direction of principal axis and phase difference by forming the wavelength plate with a photonic crystal.

Thus, a polarization state is created that is axially symmetrical about the optical axis as an axis of symmetry from the light beam emitted from the light source, circular polarization is obtained at the central optical axis, the ellipticity of the polarized light changes so as to decrease gradually with increasing distance from the optical axis, and each elliptically polarized light is in a polarization state such that the long axis of the ellipse is oriented in the circumferential direction of the circle centered on the optical axis. The ellipticity is defined as a ratio of the long axis and short axis, the ellipticity equal to 0 represents linearly polarized light, and the ellipticity equal to 1 represents a circularly polarized light. As a result, the evanescent wave propagates with good efficiency and the S-polarized component is larger than the P-polarized component. Therefore, the component in which the orientations of electric field vectors are aligned is intensified and a minuter spot can be formed. As a result, the effective NA increases and information can be recorded or reproduced at a higher density.

Further, in the present embodiment, an example is described in which focus detection is performed by an astigmatism method and tracking detection is performed by a push-pull method, but such configurations are not limiting and combinations with other detection systems may be used. Furthermore, a configuration is described in which the photodetector used for gap detection is separate from the photodetector used for focus detection and tracking detection, but a unified photodetector suitable for gap detection, focus detection, and tracking detection may be also provided.

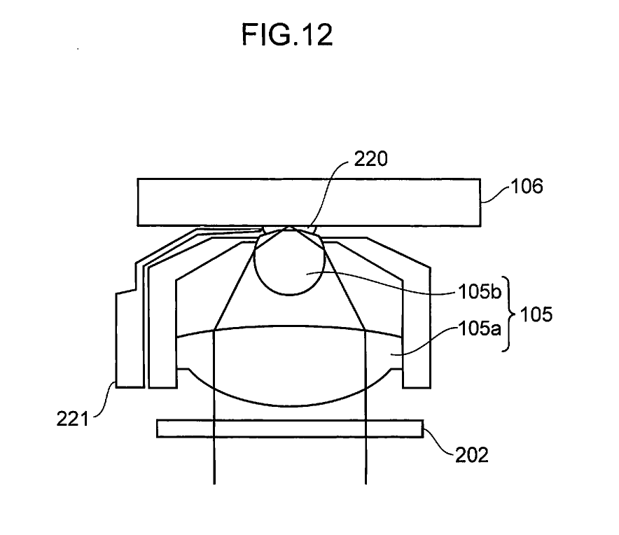

In Embodiment 1, an example is described in which an air gap is formed between the SIL 105b and the optical recording medium 106 and the light propagates as evanescent light between the SIL 105b and the optical recording medium 106. However, a configuration may be also used in which, as shown in FIG. 12, an oil 220 with a high refractive index is loaded and maintained between the SIL 105b and the optical recording medium 106, and the oil 220 may be used as an immersion lens. The oil 220 may be supplied from an oil reservoir 221 as necessary. In this case, where the polarization with the distribution such as described in the present embodiment is realized, the effective NA can be also increased by comparison with that of the circularly polarized light or the like, a minute spot can be formed and the effects similar to those indicated in the present embodiment can be obtained.

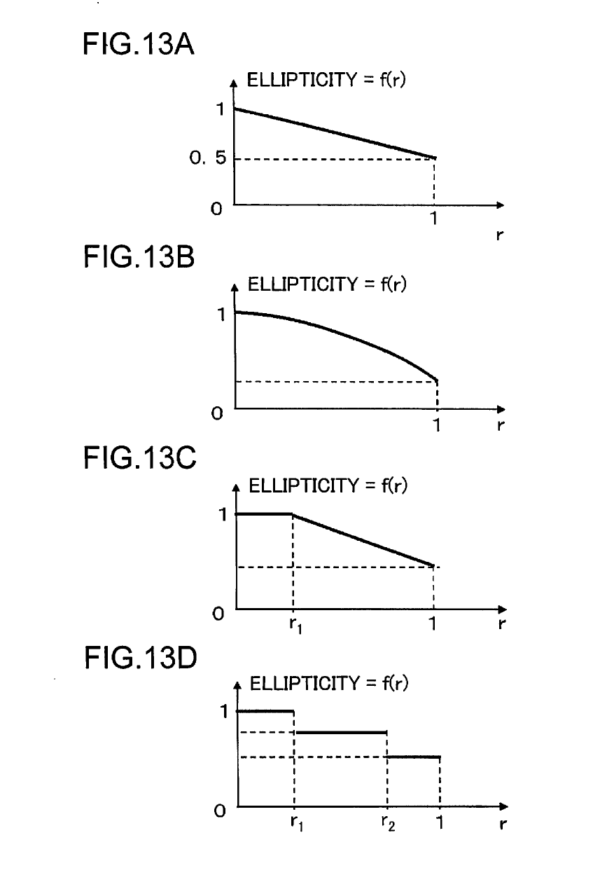

Further, in the present embodiment, an example is described (FIG. 13A) in which a first-order function is considered as the function f(r) representing changes in the ellipticity of polarized light with the distance from the optical axis, but such a function is not limiting. Thus, a second-order function (FIG. 13B) or a function more complex than the second-order function may be also used. Alternatively, a function (FIG. 13C) may be used such that the ellipticity is flat ((f(r)=1) as far as a predetermined radius (normalized radius) r1 from the optical axis and the ellipticity f(r) decreases with increasing distance from the predetermined radius r1 toward the outer circumference. A step function that changes in a stepwise manner may be also used such as a step function in which the ellipticity decreases at positions of the normalized radius r1 and the normalizer radius r2, as shown in FIG. 13D. The ellipticity of part of the light ray that is far from the optical axis may decrease as a function. In FIG. 13A to FIG. 13D, r represents a normalized radius obtained by normalizing the distance from a predetermined position of the light beam to the optical axis by the light beam radius.

In the case of the step function such as shown in FIG. 13D, the polarization converting element that generates a polarization state with a changing ellipticity can be produced easier than in the case of functions such as shown in FIG. 13A and FIG. 13B. The step function is not limited to the step function such as shown in FIG. 13D. Thus, a step function may be used such that the ellipticity of the elliptically polarized light at each position decreases with increasing distance from the optical axis at a total of n (n is a constant equal to or greater than 1) positions in which the distance from the optical axis (normalized radius r) increases in the order of r1, r2, . . . , rn from the optical axis.

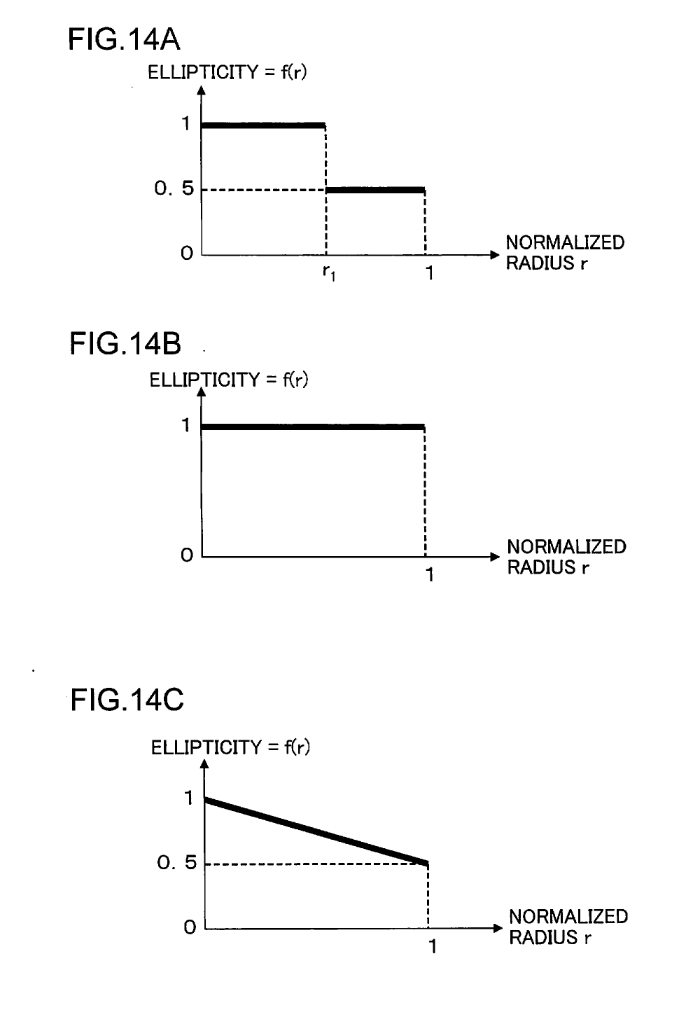

The results obtained in comparing the full width at half maximum of the spot and the Strehl intensity for three examples shown in FIGS. 14A to 14C are explained below. FIG. 14A shows the ellipticity that changes according to a step function. In FIG. 14A, from the optical axis (normalized radius r=0) to a position with the normalized radius r1, the ellipticity is 1, and from the position with the normalized radius r1 to the end of the wavelength plate 202 (normalized radius r=1), the ellipticity is 0.5. FIG. 14B shows the ellipticity in the case of a full-plane circularly polarized light. In FIG. 14B, the ellipticity is 1 at all positions. FIG. 14C shows the ellipticity changing according to a first-order function. In FIG. 14C, the ellipticity at the optical axis (normalized radius r=0) is 1, the ellipticity at the end of the wavelength plate 202 (normalized radius r=1) is 0.5, and the ellipticity between the optical axis and the end of the wavelength plate 202 decreases linearly. Thus, the first-order function representing the ellipticity is f(r)=1−0.5r.

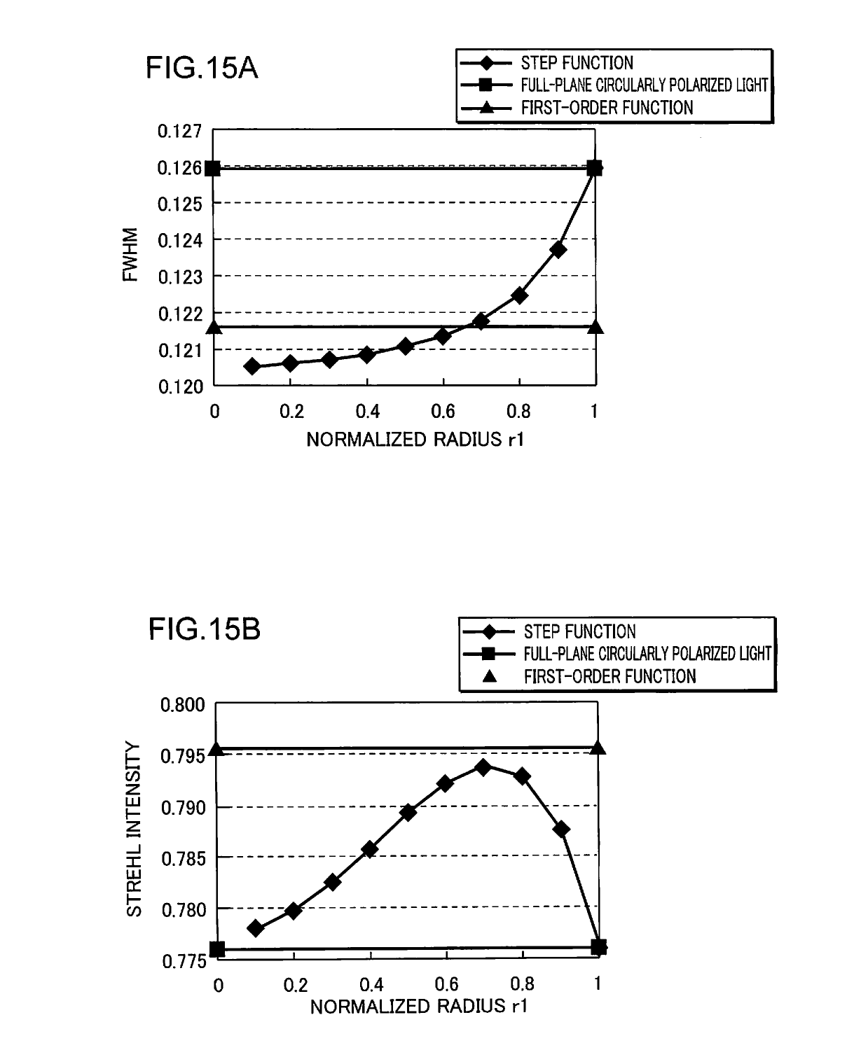

FIG. 15A illustrates the relationship between the full width at half maximum (FWHM) of the spot and the normalized radius with respect to the ellipticity presented in FIGS. 14A to 14C. FIG. 15B illustrates the relationship between the Strehl intensity of the spot and the normalized radius with respect to the ellipticity presented in FIGS. 14A to 14C.

In FIG. 15A and FIG. 15B, the full width at half maximum and the Strehl intensity relating to the case where the normalized radius r1 that reduces the ellipticity to 0.5 is changed according to the step function shown in FIG. 14A are shown by rhomboidal points. In FIG. 15A and FIG. 15B, for comparison, the full width at half maximum and the Strehl intensity relating to the case shown in FIG. 14B where the full plane is the circularly polarized light are represented by a line connecting two tetragonal points. Further, in FIG. 15A and FIG. 15B, the full width at half maximum and the Strehl intensity relating to the case of the first-order function shown in FIG. 14C are represented by a line connecting two triangular points.

It follows from FIG. 15A and FIG. 15B that when the ellipticity is represented by a step function and a first-order function as shown in FIG. 14A and FIG. 14C, the full width at half maximum is lower and the Strehl intensity is higher than those in the case where the full plane is the circularly polarized light as shown in FIG. 14B. Thus, it is preferred that part of the light ray other than the light ray on the optical axis be an elliptically polarized light with an ellipticity less than 1, as in the case of step function and first-order function such as shown in FIG. 14A and FIG. 14C.

Further, it is preferred that part of the light ray other than the light ray on the optical axis pass through a position on the wavelength plate at which the normalized radius r is equal to or greater than 0.6. Thus, where part of a light ray, in particular of a light ray with a large angle of incidence in the converged light such as in the portion with a normalized radius r equal to or greater than 0.6, is made an elliptically polarized light, the S-polarized component becomes larger than the P-polarized component, a component with aligned orientations of electric field vectors is increased, and a minuter spot can be formed.

Further, it is preferred that where the ellipticity of polarized light at a first normalized radius ra at a predetermined distance from the optical axis is taken as a first ellipticity, and an ellipticity of polarized light at a second normalized radius rb that is farther than the first normalized radius ra from the optical axis is taken as a second ellipticity, the wavelength plate 202 convert a polarization state of the light beam so that the second ellipticity becomes less than the first ellipticity. As a result, a spot can be formed that is minuter than that in the polarization state in which the ellipticity increases with increasing distance from the optical axis.

Further, as follows from FIG. 15A and FIG. 15B, when the normalized radius r1 is equal to or greater than 0.8, the full width at half maximum of the spot increases and the Strehl intensity decreases with respect to those in the case where the normalized radius r1 is less than 0.8. Therefore, when the ellipticity is a step function, it is more preferred that the ellipticity decrease at a predetermined position with a normalized radius r from 0.6 to 0.8 and an elliptically polarized light with an ellipticity of less than 1 be obtained. Thus, with the configuration in which the ellipticity decreases at a predetermined position with a normalized radius r from 0.6 to 0.8, the full width at half maximum of the spot can be increased and the Strehl intensity can be decreased.

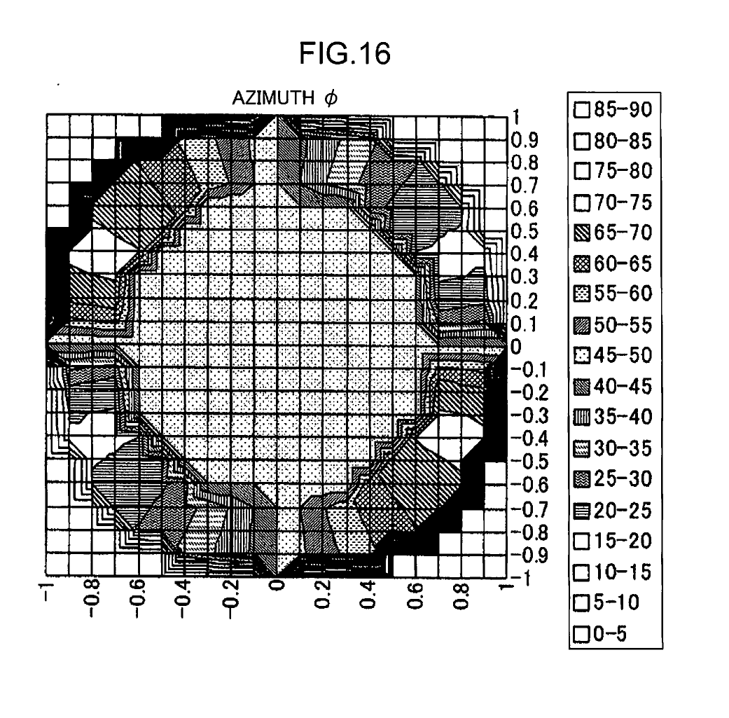

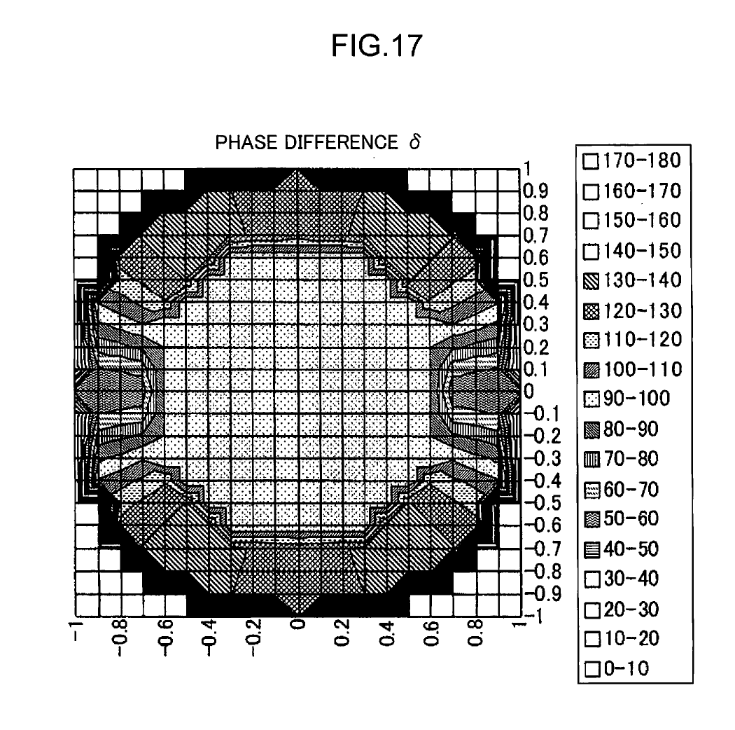

As an example, FIG. 16 and FIG. 17 illustrate the configuration in which the ellipticity decreases at a position with a normalized radius r of 0.7, that is, illustrate an example of distribution of the azimuth φ and the phase difference δ of the wavelength plate with a normalized radius r1 equal to 0.7 in FIG. 15A and FIG. 15B. FIG. 16 represents by contour lines the distribution of the azimuth of the principal axis of birefringence in the case where the ellipticity decreases at a position with a normalized radius r of 0.7. FIG. 17 represents by contour lines the distribution of the phase difference of birefringence in the case where the ellipticity decreases at a position with a normalized radius r of 0.7.

Further, in the case of the first-order function such as shown in FIG. 14C, the full width at half maximum of the spot decreases and the Strehl intensity increases with respect to those in the case of the step function and the full-plane circularly polarized light such as shown in FIG. 14A and FIG. 14B. This result is obtained in the case of a first-order function with an ellipticity of f(r)=1−0.5r, but such a function is not limiting. For example, the full width at half maximum of the spot likewise decreases and the Strehl intensity likewise increases also when the ellipticity decreases according to the second-order function such as shown in FIG. 13B. Therefore, it is more preferred that the wavelength plate 202 convert the polarization state of the light beam to a distribution in which the ellipticity of the polarized light changes so as to decrease gradually with increasing distance from the optical axis, as represented by the first-order function and second-order function shown in FIG. 13A and FIG. 13B.

Further, the cases considered in the present embodiment involve a first-order function and a second-order function such that the ellipticity of the polarized light changes so as to decrease gradually with increasing distance from the optical axis, or a step function such that the ellipticity of the elliptically polarized light at each position of the normalized radii r1, r2, . . . , rn decreases gradually with a distance from the optical axis, but such configurations are not limiting. Thus, a configuration may be used in which part of the light ray other than the light ray on the optical axis is an elliptically polarized light with an ellipticity less than 1. Where part of the light ray other than the light ray on the optical axis is thus made an elliptically polarized light, the S-polarized component becomes larger than the P-polarized component, the component with aligned directions of electric field vectors increases, and a minuter spot can be formed.

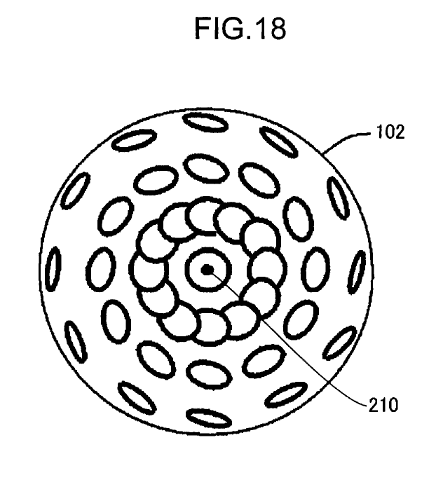

Further, in the present embodiment, an example is described in which the long axis of the elliptically polarized light is entirely oriented in the circumferential direction, but such a configuration is not limiting. Since it is preferred that the S-polarized component be larger than the P-polarized component, the long axis direction of the elliptically polarized light may be at a predetermined angle with respect to the circumferential direction, as shown in FIG. 18. Thus, an angle formed by the long axis direction of the elliptically polarized light and a circumferential direction of a circle centered on the light axis may be less than ±45 degrees, so that the S-polarized component contained in the elliptically polarized light increase over the S-polarized component contained in the circularly polarized light.

It is further preferred that the angle formed by the long axis direction of the elliptically polarized light and a circumferential direction of a circle centered on the light axis be 0 degrees. Thus, it is preferred that the angle formed by the long axis direction of the elliptically polarized light and a circumferential direction of a circle centered on the light axis be parallel to each other. When the angle formed by the long axis direction of the elliptically polarized light and a circumferential direction of a circle centered on the light axis be parallel to each other (the angle formed by the long axis direction of the elliptically polarized light and a circumferential direction of a circle centered on the light axis is 0 degrees), the elliptically polarized light with the largest increase in the S-polarized component is obtained, the component with aligned orientation of electric field vectors is increased, and a minuter spot can be formed.

This embodiment illustrates an example of the distribution of phase difference and the distribution of the azimuth of the principal axis of birefringence of the wavelength plate for obtaining the target polarization distribution, but the distribution of phase difference and the distribution of the azimuth of the principal axis of birefringence of the wavelength plate are not limited to the distributions described hereinabove. In the present embodiment, ideal distributions are shown in which the azimuth of the principal axis and the phase difference change smoothly, but the effects substantially similar to those described in the present embodiment are also obtained with the wavelength plate which is divided into a plurality of regions with consideration for the easiness of production and which has constant azimuth and phase difference in each divided region.

Further, an example is described in which a wavelength plate is used as a means for obtaining the desired polarization distribution in the present embodiment, but such a configuration is not limiting. For example, where a spherical dielectric mirror is irradiated with a circularly polarized light ray, the polarization distribution of the light reflected therefrom will be such as shown in FIG. 2A. This is because the light ray radiated to the position passing through the center of the spherical mirror becomes an orthogonal incident light and therefore the circular polarization is maintained, but the light rays other than that passing through the center fall obliquely according to the orientation thereof and typically become elliptically polarized light upon reflection. In the polarization of the reflected wave, the P-polarized component typically decreases and the S-polarized component typically increases as the angle of incidence changes from the orthogonal incidence in the direction of Brewster angle. At the Brewster angle, the S-polarized linearly polarized light is obtained. Thus, the effects substantially similar to those described in the present embodiment are also obtained where the convergence is performed, while maintaining the polarization state, even when the light reflected by the dielectric is used and the polarization distribution such as shown in FIG. 2A is obtained.

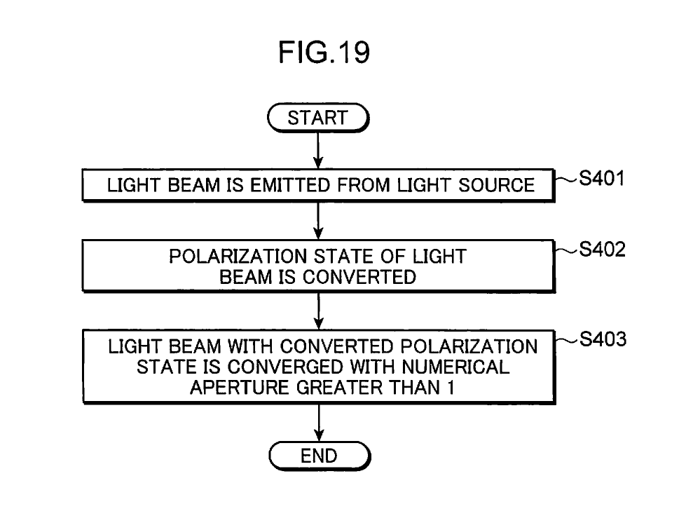

As shown in FIG. 19, with the method for forming a minute spot according to the present embodiment, a minute spot is formed by successively implementing a step of emitting a light beam from a light source (semiconductor layer 101) (S401), a step of converting the polarization state of the light beam emitted from the light source by a polarization converting element (wavelength plate 202) (S402), and a step of converting the light beam, which has the polarization state converted by the polarization converting element, with the objective lens optical system 105 with a numerical aperture greater than 1 (S403). In this case, the wavelength plate 202 generates a light beam having a polarization state that differs depending on location, a polarization distribution of the light beam generated by the wavelength plate 202 is axially symmetric with respect to an optical axis of the light beam as an axis of symmetry, a light ray on the light axis is a circularly polarized light, part of a light ray other than the light ray on the optical axis is an elliptically polarized light with an ellipticity of less than 1, and an angle formed by a long axis of an ellipse and a circumferential direction of a circle centered on the light axis in each elliptically polarized light is less than ±45 degrees. With such a polarization distribution, it is possible to obtain the effects similar to those described in the present embodiment.

### Embodiment 2

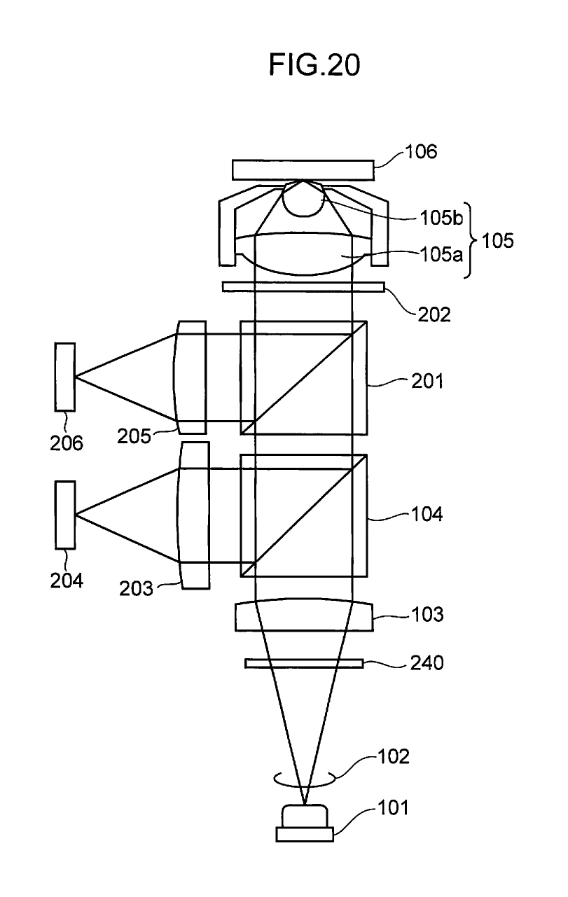

FIG. 20 illustrates the configuration of the optical pickup in Embodiment 2 of the present invention. In FIG. 20, constituent components same as those in FIG. 1 are assigned with same reference numerals and the explanation thereof is herein omitted.

In FIG. 20, the optical pickup is provided with a semiconductor laser 101, a converging lens 103, beam splitters 104, 201, a wavelength plate 202, an objective lens optical system 105, a detection lens 203, a photodetector 204, a detection lens 205, a photodetector 206, and a transmission filter 240.

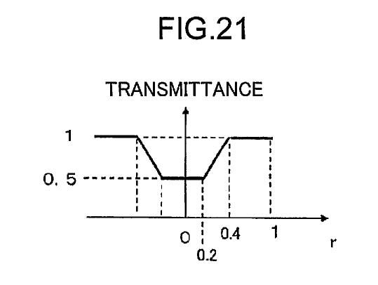

The transmission filter 240 reduces the quantity of light in the central portion of the light beam 102 emitted from the semiconductor layer 101 to below the quantity of light in the end portion of the light beam 102. The transmission filter 240 is provided between the semiconductor layer 101 and the objective lens optical system 105 and has a transmittance distribution such that the quantity of transmitted light near the optical axis is lower than the quantity of transmitted light near the end portion. FIG. 21 is a plot diagram illustrating the transmittance distribution of the transmission filter 240 in Embodiment 2 of the present invention. The transmittance of the transmission filter 240 is low in the central portion (the optical axis serves as a center) and increases at positions far from the optical axis. As shown in FIG. 21, for example, the transmittance from the optical axis to the normalized radius 0.2 is 0.5, the transmittance from the normalized radius 0.2 to the normalized radius 0.4 increases gradually from 0.5 to 1, and the transmittance from the normalized radius 0.4 to the normalized radius 1 is 1.

In the case of such a configuration, in addition to the polarization distribution effect described in Embodiment 1, the ratio of the light ray with a large angle of incidence in the entire light is increased and the spot size can be further decreased. Therefore, information can be recorded or reproduced at a high density.

FIG. 21 shows a specific example of transmittance distribution in the transmission filter 240, but such a distribution is not limiting and the effect similar to that of the present embodiment can be also obtained where the transmittance close to the optical axis is lower than that at a position at a distance from the optical axis.

### Embodiment 3

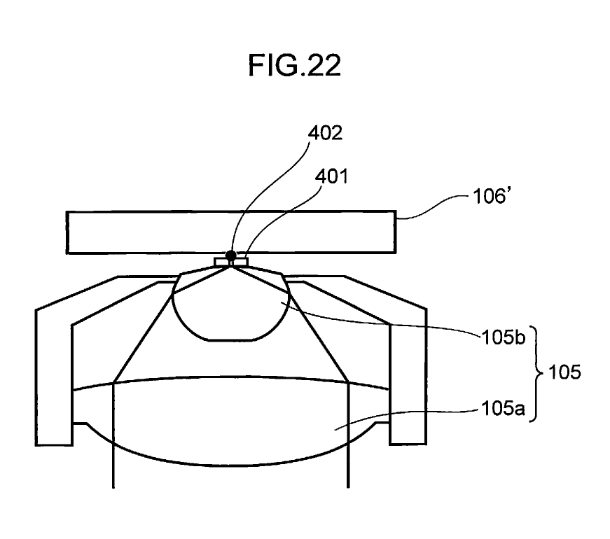

FIG. 22 shows the configuration of the optical pickup according to Embodiment 3 of the present invention. In FIG. 22, constituent element same as shown in FIG. 1 are assigned with same reference numerals and the explanation thereof is omitted. In FIG. 22, only the configuration close to the objective lens optical system 105 is shown. In Embodiment 3, the components other than a near-field light generating element 401 are identical to those of the optical pickup in Embodiment 1 or Embodiment 2.

The optical pickup of Embodiment 3 is further provided with a near-field light-generating element 401, which generates near-field light, between the SIL 105b and the optical recording medium 106′. The near-field light-generating element 401 is, for example, a metal plate that is, as a whole, larger than the spot of the converged light and is formed to have a narrow elongated shape on the flat rear surface (surface from which the recording light or reproducing light is emitted) of the SIL 105b. The near-field light-generating element 401 is for example of a shape (not shown in the figure) such that has a very small orifice opened in part of the metal plate interior and a protruding portion in which part of the very small orifice is tapered off. It is preferred that a material that demonstrates plasmon resonance at a wavelength of the light beam that is used be selected as a material of the metal plate. For example, the metal plate may be constituted by Au or the like.

The converged light that has been converged by the SIL 105b is collected by the near-field light-emitting element 401. As a result, the near-field light 402 is generated by the plasmon resonance. The near-field light 402 is radiated to an optical recording medium 106′, thereby making it possible to record or reproduce information.

As explained in Embodiment 1, the optical pickup of Embodiment 3 creates a polarization state that is axially symmetrical, with the optical axis as an axis of symmetry, from the light beam emitted from the light source. In the light beam converted by the wavelength plate 202, part of the light ray other that the light ray on the optical axis is an elliptically polarized light with an ellipticity less than 1 and in this polarization state, the angle formed by the long-axis direction of the elliptically polarized light and the circumferential direction of a circle centered on the optical axis is less than ±45 degrees.

As a result, the S-polarized component becomes larger than the P-polarized component even when the angle of incidence is large, the component with aligned orientation of electric field vectors is increased, and a minuter spot can be formed. Therefore, with the optical pickup of Embodiment 3, a minuter converged spot can be converged at the near-field light-generating element 401. Thus, the light with a higher intensity can be converged on the near-field light-generating element 401. A plasmon resonance is thereby effectively induced. As a result, the intensity of the near-field light spot on the optical recording medium 106′ also increases and high-density information recording or reproducing can be performed.

### Embodiment 4

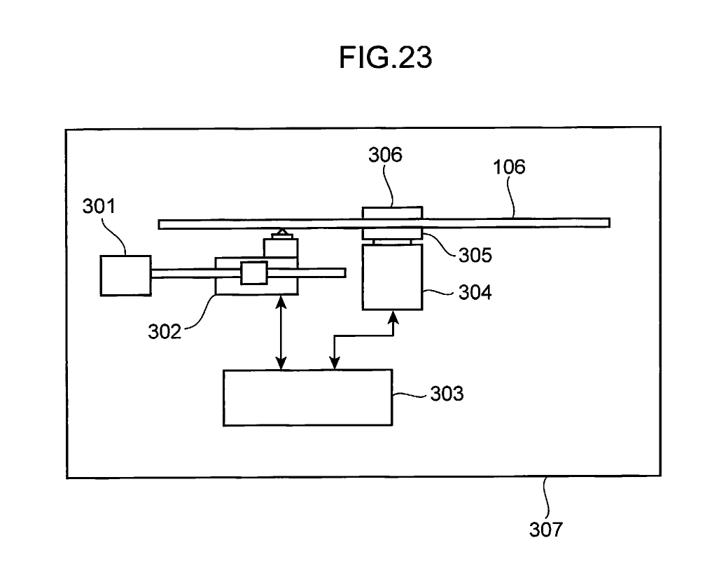

FIG. 23 shows an embodiment of an optical recording/reproducing device using an optical pickup of Embodiment 1, Embodiment 2, or Embodiment 3. FIG. 23 shows a schematic configuration of the optical recording/reproducing device in Embodiment 4 of the present invention. In FIG. 23, an optical recording/reproducing device 307 is provided with a drive unit 301, an optical pickup 302, an electric circuit (control unit) 303, and a motor 304.

The optical recording medium 106 is placed on a turntable 305, held by a damper 306, and rotated by the motor 304. The optical pickup 302 is the optical pickup described in Embodiment 1, Embodiment 2, or Embodiment 3. The drive device 301 transfers the optical pickup 302 described in Embodiment 1, Embodiment 2, or Embodiment 3 to a track of the optical recording medium 106 where the desired information is present.

The electric circuit 303 controls the optical pickup 302 and the motor 304 on the basis of signals obtained from the optical pickup 302. The optical pickup 302 sends a focus signal, a tracking signal, a gap signal, and a RF signal to the electric circuit 303 correspondingly to the positional relationship with the optical recording medium 106. The electric circuit 303 sends signals for driving the objective lens actuator to the optical pickup 302 in response to the aforementioned signals. The focus control, tracking control, or gap control of the optical recording medium 106 is performed by the optical pickup 302, and information is read, written, or deleted on the basis of the received signals.

In the explanation above, the optical recording medium 106 placed on the optical recording/reproducing device 307 has a recording layer for recording or reproducing information by near-field light. Since the optical recording/reproducing device 307 of Embodiment 4 uses the optical pickup of Embodiment 1, Embodiment 2, or Embodiment 3, a minute spot can be formed and the information can be recorded or reproduced with a high density on or from the recording layer.

### Embodiment 5

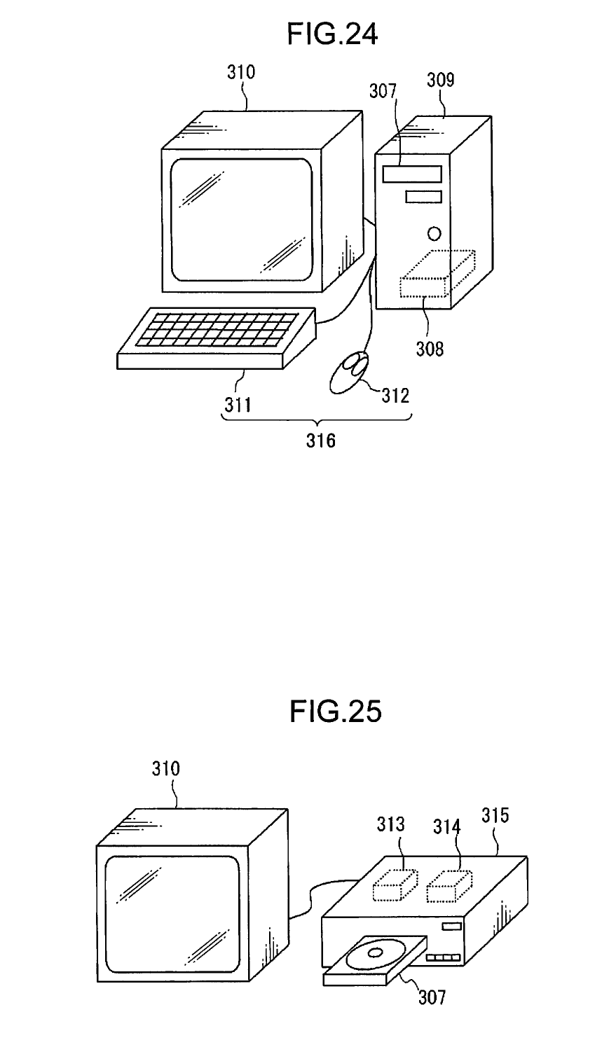

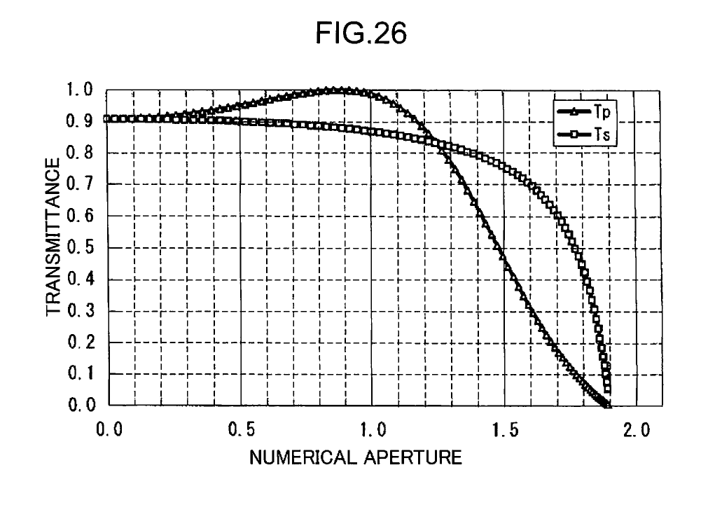

Embodiment 5 relates to a computer including the optical recording/reproducing device 307 of Embodiment 4. FIG. 24 is a schematic perspective view illustrating the entire configuration of the computer in Embodiment 5 of the present invention. A computer 309 shown in FIG. 24 is provided with the optical recording/reproducing device 307 of Embodiment 4, an input device (input unit) 316 such as a keyboard 311 and a mouse 312 for performing information input, a computation device (computation unit) 308 such as a CPU that performs computations on the basis of at least either of the information inputted from the input device 316 and the information reproduced by the optical recording/reproducing device 307, and an output device (output unit) 310 such as a cathode-ray tube or a liquid crystal display device that displays at least any one of the information inputted from the input device 316, the information reproduced by the optical recording/reproducing device 307, and the result computed by the computation device 308.

The computer of Embodiment 5 includes the optical recording/reproducing device 307 of Embodiment 4 and can stably record or reproduce information on or from an optical recording medium having a recording layer for recording or reproducing information by using the near-field light. Therefore, such a computer has a wide range of application.

### Embodiment 6

Embodiment 6 relates to an optical disk recorder provided with the optical recording/reproducing device 307 of Embodiment 4. FIG. 25 is a schematic perspective view illustrating the entire configuration of the optical disk recorder in Embodiment 6 of the present invention. An optical disk recorder 315 shown in FIG. 25 is provided with the optical recording/reproducing device 307 of Embodiment 4 and a recording signal processing circuit (recording signal processing unit) 313 that converts image information into information signals for recording on the optical recording medium with the optical recording/reproducing device 307.

It is desirable that the optical disk recorder 315 have a reproduction signal processing circuit (reproduction signal processing unit) 314 for converting information signals obtained from the optical recording/reproducing device 307 into image information. With such a configuration, the already recorded information can be reproduced. The optical disk recorder 315 may be provided with the output device 310 such a cathode-ray tube or a liquid crystal display device that displays information.

The optical disk recorder of Embodiment 6 includes the optical recording/reproducing device 307 of Embodiment 4 and can stably record or reproduce information on or from an optical recording medium having a recording layer for recording or reproducing information by using the near-field light. Therefore, such an optical disk recorder has a wide range of application.

The above-described specific embodiments mainly include the invention having the below-described configuration.

The optical pickup according to the first aspect of the present invention records or reproduces information on or from an optical recording medium by using a light beam emitted from a light source, the optical pickup including: a polarization converting element that converts a polarization state of the light beam emitted from the light source; and an objective lens optical system that converges the light beam, whose polarization state has been converted by the polarization converting element, with a numerical aperture greater than 1, wherein the polarization converting element generates a light beam having a polarization state that differs depending on location; a polarization distribution of the light beam generated by the polarization converting element is axially symmetric with respect to an optical axis of the light beam as an axis of symmetry; a light ray on the light axis is a circularly polarized light; part of a light ray other than the light ray on the optical axis is an elliptically polarized light with an ellipticity of less than 1; and an angle formed by a long axis of an ellipse and a circumferential direction of a circle centered on the light axis in each elliptically polarized light is less than ±45 degrees.

With such a configuration, the polarization converting element converts the polarization state of the light beam emitted from the light source, and the objective lens optical system converges the light beam, which has a polarization state converted by the polarization converting element, with a numerical aperture greater than 1. The polarization converting element generates a light beam having a polarization state that differs depending on location. The polarization distribution of the light beam generated by the polarization converting element is axially symmetric with respect to the optical axis of the light beam as an axis of symmetry, a light ray on the light axis is a circularly polarized light and part of a light ray other than the light ray on the optical axis is an elliptically polarized light with an ellipticity of less than 1. The angle formed by a long axis of an ellipse and a circumferential direction of a circle centered on the light axis in each elliptically polarized light is less than ±45 degrees.

Therefore, in the light ray at a position far from the optical axis, the S-polarized component is larger than the P-polarized component and the light can be caused to propagate with a high transmittance. Since the S-polarized component increases also when a spot is formed, the component with aligned directions of electric field vectors increases and a minute spot can be formed.

Further, in the abovementioned optical pickup, it is preferred that where a value obtained by normalizing a distance from a predetermined position of the light beam to the optical axis by a radius of the light beam is defined as a normalized radius r, part of the light ray other than the light ray on the optical axis passes through a position on the polarization converting element in which the normalized radius r is equal to or greater than 0.6.

With such a configuration, part of a light ray with a large angle of incidence of the converged light, that is, a light ray that has been transmitted through a position on the polarization converting element with a normalized radius r equal to or greater than 0.6, is made an elliptically polarized light. As a result, the S-polarized component becomes larger than the P-polarized component, the component with aligned directions of electric field vectors increases, and a minuter spot can be formed.

In the abovementioned optical pickup, it is preferred that where a value obtained by normalizing a distance from a predetermined position of the light beam to the optical axis by a radius of the light beam is defined as a normalized radius r, the normalized radius r include n is a constant number equal to or greater than 1) normalized radii r1, r2, . . . , rn that increase in the order of description from the optical axis; and an ellipticity of elliptically polarized light at positions of the normalized radii r1, r2, . . . , rn decrease with increasing distance from the optical axis.

With such a configuration, the ellipticity of the elliptically polarized light decreases in a stepwise manner with increasing distance from the optical axis. Therefore, a polarization converting element can be easily produced.

Further, in the abovementioned optical pickup, it is preferred that the ellipticity decrease at a predetermined position with a normalized radius r from 0.6 to 0.8.

With such a configuration, since the ellipticity decreases at a predetermined position with a normalized radius r from 0.6 to 0.8, the full width at half maximum of the spot can be decreased and the Strehl intensity of the spot can be increased.

Further, in the abovementioned optical pickup, it is preferred that where an ellipticity of polarized light at a first normalized radius ra obtained by normalizing a distance from a predetermined position of the light beam to the optical axis by a radius of the light beam is defined as a first ellipticity, and an ellipticity of polarized light at a second normalized radius rb that is larger than the first normalized radius ra is defined as a second ellipticity, the polarization converting element convert a polarization state of the light beam so that the second ellipticity becomes less than the first ellipticity.

With such a configuration, since the polarization converting element converts a polarization state of the light beam so that the second ellipticity becomes less than the first ellipticity, it is possible to form a spot that is minuter than that in the polarization state in which the ellipticity increases with increasing distance from the optical axis.

Further, in the abovementioned optical pickup, it is preferred that the polarization converting element convert a polarization state of the light beam into a distribution such that an ellipticity of the polarized light decreases with increasing distance from the optical axis.

With such a configuration, since the polarization state of the light beam is converted to a distribution such that the ellipticity of the polarized light decreases with increasing distance from the optical axis, the full width at half maximum of the spot can be decreased and the Strehl intensity of the spot can be increased.

Further, in the abovementioned optical pickup, it is preferred that the long axis of the ellipse of the elliptically polarized light be parallel to the circumferential direction of a circle centered on the optical axis.

With such a configuration, since the S-polarized component increases the most when the long axis of the ellipse of the elliptically polarized light is parallel to the circumferential direction of a circle centered on the optical axis, the component with aligned directions of electric field vectors increases and a minute spot can be formed.

Further, in the abovementioned optical pickup, it is preferred that the light source emit a light beam of a linearly polarized light; and the polarization converting element: have an optical characteristic such that an azimuth of a principal axis of birefringence and a phase difference differ depending on location; have an optical characteristic such that the phase difference becomes 90 degrees on the optical axis; have an optical characteristic such that the phase difference approaches 180 degrees with increasing distance from the optical axis in a direction parallel to a polarization direction of an electric field vector of linear polarization of the incident light; have an optical characteristic such that the phase difference approaches 0 degrees with increasing distance from the optical axis in a direction perpendicular to the polarization direction of the electric field vector; and have an optical characteristic such that the azimuth of the principal axis of birefringence and the phase difference vary depending on location in a direction within an angle between a direction parallel to the polarization direction of the electric field vector and a direction perpendicular to the polarization direction of the electric field vector.

With such a configuration, the polarization converting element: has an optical characteristic such that the phase difference becomes 90 degrees on the optical axis; has an optical characteristic such that the phase difference approaches 180 degrees with increasing distance from the optical axis in a direction parallel to a polarization direction of an electric field vector of linear polarization of the incident light; has an optical characteristic such that the phase difference approaches 0 degrees with increasing distance from the optical axis in a direction perpendicular to the polarization direction of the electric field vector; and has an optical characteristic such that the azimuth of the principal axis of birefringence and the phase difference vary depending on location in a direction within an angle between a direction parallel to the polarization direction of the electric field vector and a direction perpendicular to the polarization direction of the electric field vector. Therefore, the light beam incident upon the polarization converting element can be converted to a polarization state such that the ellipticity of the polarized light decreases with increasing distance from the optical axis.

Further, in the abovementioned optical pickup, it is preferred that the polarization converting element be an optical element based on a photonic crystal. With such a configuration, a principal axis direction and a phase difference of any shape can be produced.

Further, in the abovementioned optical pickup, it is preferred that the optical pickup further include a transmission filter that is provided between the light source and the objective lens optical system and has a transmittance distribution such that a transmitted light amount close to the optical axis is less than a transmitted light amount close to an end portion.

With such a configuration, the transmission filter is provided between the light source and the objective lens optical system and has a transmittance distribution such that a transmitted light amount close to the optical axis is less than a transmitted light amount close to an end portion. Where the light beam passes through the transmission filter, the ratio of the light ray with a large angle incidence in the entire light increases and the spot can be converged to a smaller size.

Further, in the abovementioned optical pickup, it is preferred that the objective lens optical system and the optical recording medium be held at a distance from each other that is less than the wavelength of the light beam; and the objective lens optical system emit evanescent light. With such a configuration, a minute spot can be formed by the evanescent light.

Further, in the abovementioned optical pickup, it is preferred that the optical pickup further include a near-field light-generating element that is provided between the objective lens optical system and the optical recording medium and generates near-field light, wherein the objective lens optical system collects a converged light on the near-field light-generating element; and the near-field light-generating element radiates the generated near-field light to the optical recording medium.

With such a configuration, the objective lens optical system collects a converged light on the near-field light-generating element; and the near-field light-generating element provided between the objective lens optical system and the optical recording medium radiates the generated near-field light to the optical recording medium.

Therefore, light of higher intensity can be collected on the near-field light-emitting element. As a consequence, a plasmon resonance often occurs. As a result, the intensity of the near-field light spot on the optical recording medium also increases and high-sensitivity information can be recorded or reproduced.

An optical recording/reproducing device according to another aspect of the present invention includes any one of the above-described optical pickups; a motor for rotationally driving the optical recording medium; and a control unit that controls the optical pickup and the motor on the basis of a signal obtained from the optical pickup. With such a configuration, the abovementioned optical pickup can be applied to an optical recording/reproducing device.

A computer according to another aspect of the present invention includes the above-described optical recording/reproducing device; an input unit that inputs information; a computation unit that performs computations on the basis of either of information inputted by the input unit and information reproduced by the optical recording/reproducing device; and an output unit that outputs at least any one of the information inputted from the input device, the information reproduced by the optical recording/reproducing device, and a result computed by the computation device. With such a configuration, the abovementioned optical recording/reproducing device including the optical pickup can be applied to a computer.

An optical disk recorder according to another aspect of the present invention includes the above-described optical recording/reproducing device; a recording signal processing unit that converts image information into an information signal for recording by the optical recording/reproducing device; and a reproduction signal processing unit that converts the information signal obtained from the optical recording/reproducing device into image information. With such a configuration, the abovementioned optical recording/reproducing device including the optical pickup can be applied to an optical disk recorder.

A minute spot forming method according to another aspect of the present invention includes a step of emitting a light beam from a light source; a step of converting a polarization state of the light beam emitted from the light source by a polarization converting element, and a step of converging the light beam, whose polarization state has been converted by the polarization converting element, with a numerical aperture greater than 1, wherein the polarization converting element generates a light beam having a polarization state that differs depending on location; a polarization distribution of the light beam generated by the polarization converting element is axially symmetric with respect to an optical axis of the light beam as an axis of symmetry; a light ray on the light axis is a circularly polarized light; part of a light ray other than the light ray on the optical axis is an elliptically polarized light with an ellipticity of less than 1; and an angle formed by a long axis of an ellipse and a circumferential direction of a circle centered on the light axis in each elliptically polarized light is less than ±45 degrees.

With such a configuration, a light beam is emitted from a light source, the polarization state of the light beam emitted from the light source is converted by the polarization converting element, and the light beam with the polarization state converted by the polarization converting element is converged by the objective lens optical system with a numerical aperture greater than 1. The polarization converting element generates a light beam having a polarization state that differs depending on location. The polarization distribution of the light beam generated by the polarization converting element is axially symmetric with respect to an optical axis of the light beam as an axis of symmetry. A light ray on the light axis is a circularly polarized light. Part of a light ray other than the light ray on the optical axis is an elliptically polarized light with an ellipticity of less than 1. An angle formed by a long axis of an ellipse and a circumferential direction of a circle centered on the light axis in each elliptically polarized light is less than ±45 degrees.

Therefore, in the light ray at a position far from the optical axis, the S-polarized component is larger than the P-polarized component and the light can be caused to propagate with a high transmittance. Further, since the S-polarized component increases also when a spot is formed, the component with aligned directions of electric field vectors increases and a minute spot can be formed.

Specific embodiments or examples described in Description of Embodiments are merely for clarifying the technical contents of the present invention. Thus, the present invention should not be construed narrowly as being limited to these specific examples, and can be implemented with various modifications within the spirit of the present invention and the scope of the claims.

### INDUSTRIAL APPLICABILITY

With the optical pickup, optical recording/reproducing device, computer, optical disk recorder and minute spot forming method in accordance with the present invention, stable recording or reproduction of information is possible and high-density information can be recorded on an optical recording medium by a minute spot created by an objective lens with a high numerical aperture, such that has a numerical aperture greater than 1. Therefore, the present invention can be used in high-capacity optical disk recorders or memory devices for computers, which are application examples of optical recording/reproducing devices.

1. An optical pickup that records or reproduces information on or from an optical recording medium by using a light beam emitted from a light source,
the optical pickup comprising:
a polarization converting element that converts a polarization state of the light beam emitted from the light source; and
an objective lens optical system that converges the light beam, whose polarization state has been converted by the polarization converting element, with a numerical aperture greater than 1, wherein
the polarization converting element generates a light beam having a polarization state that differs depending on location;
a polarization distribution of the light beam generated by the polarization converting element is axially symmetric with respect to an optical axis of the light beam as an axis of symmetry;
a light ray on the light axis is a circularly polarized light;
part of a light ray other than the light ray on the optical axis is an elliptically polarized light with an ellipticity of less than 1; and
an angle formed by a long axis of an ellipse and a circumferential direction of a circle centered on the light axis in each elliptically polarized light is less than ±45 degrees.

2. The optical pickup according to claim 1, wherein
where a value obtained by normalizing a distance from a predetermined position of the light beam to the optical axis by a radius of the light beam is defined as a normalized radius r,
part of the light ray other than the light ray on the optical axis passes through a position on the polarization converting element in which the normalized radius r is equal to or greater than 0.6.

3. The optical pickup according to claim 1, wherein
where a value obtained by normalizing a distance from a predetermined position of the light beam to the optical axis by a radius of the light beam is defined as a normalized radius r,
the normalized radius r includes n (n is a constant number equal to or greater than 1) normalized radii r1, r2, . . . , rn that increase in the order of description from the optical axis; and
an ellipticity of elliptically polarized light at positions of the normalized radii r1, r2, . . . , rn decreases with increasing distance from the optical axis.

4. The optical pickup according to claim 3, wherein the ellipticity decreases at a predetermined position, with a normalized radius r from 0.6 to 0.8.

5. The optical pickup according to claim 1, wherein
where an ellipticity of polarized light at a first normalized radius ra obtained by normalizing a distance from a predetermined position of the light beam to the optical axis by a radius of the light beam is defined as a first ellipticity, and
an ellipticity of polarized light at a second normalized radius rb that is larger than the first normalized radius ra is defined as a second ellipticity,
the polarization converting element converts a polarization state of the light beam so that the second ellipticity becomes less than the first ellipticity.

6. The optical pickup according to claim 1, wherein
the polarization converting element converts a polarization state of the light beam into a distribution such that an ellipticity of the polarized light decreases with increasing distance from the optical axis.

7. The optical pickup according to claim 1, wherein a long axis of the ellipse of the elliptically polarized light is parallel to a circumferential direction of a circle centered on the optical axis.

8. The optical pickup according to claim 1, wherein
the light source emits a light beam of a linearly polarized light; and
the polarization converting element:
has an optical characteristic such that an azimuth of a principal axis of birefringence and a phase difference differ depending on location;
has an optical characteristic such that the phase difference becomes 90 degrees on the optical axis;
has an optical characteristic such that the phase difference approaches 180 degrees with increasing distance from the optical axis in a direction parallel to a polarization direction of an electric field vector of linear polarization of the incident light;
has an optical characteristic such that the phase difference approaches 0 degrees with increasing distance from the optical axis in a direction perpendicular to the polarization direction of the electric field vector; and
has an optical characteristic such that the azimuth of the principal axis of birefringence and the phase difference vary depending on location in a direction within an angle between a direction parallel to the polarization direction of the electric field vector and a direction perpendicular to the polarization direction of the electric field vector.

9. The optical pickup according to claim 1, wherein the polarization converting element is an optical element based on a photonic crystal.

10. The optical pickup according to claim 1, further comprising a transmission filter that is provided between the light source and the objective lens optical system and has a transmittance distribution such that a transmitted light amount close to the optical axis is less than a transmitted light amount close to an end portion.

11. The optical pickup according to claim 1, wherein
the objective lens optical system and the optical recording medium are held at a distance from each other that is less than the wavelength of the light beam; and
the objective lens optical system emits evanescent light.

12. The optical pickup according to claim 1, further comprising a near-field light-generating element that is provided between the objective lens optical system and the optical recording medium and generates near-field light, wherein
the objective lens optical system collects a converged light on the near-field light-generating element; and
the near-field light-generating element radiates the generated near-field light to the optical recording medium.

13. An optical recording/reproducing device comprising:
the optical pickup according to claim 1;
a motor for rotationally driving the optical recording medium; and
a control unit that controls the optical pickup and the motor on the basis of a signal obtained from the optical pickup.

14. A computer comprising:
the optical recording/reproducing device according to claim 13;
an input unit that inputs information;
a computation unit that performs computations on the basis of either of information inputted by the input unit and information reproduced by the optical recording/reproducing device; and
an output unit that outputs at least any one of the information inputted from the input device, the information reproduced by the optical recording/reproducing device, and a result computed by the computation device.

15. An optical disk recorder comprising:
the optical recording/reproducing device according to claim 13;
a recording signal processing unit that converts image information into an information signal for recording by the optical recording/reproducing device; and
a reproduction signal processing unit that converts the information signal obtained from the optical recording/reproducing device into image information.

16. A minute spot forming method comprising:
a step of emitting a light beam from a light source;
a step of converting a polarization state of the light beam emitted from the light source by a polarization converting element, and
a step of converging the light beam, whose polarization state has been converted by the polarization converting element, with a numerical aperture greater than 1, wherein
the polarization converting element generates a light beam having a polarization state that differs depending on location;
a polarization distribution of the light beam generated by the polarization converting element is axially symmetric with respect to an optical axis of the light beam as an axis of symmetry;
a light ray on the light axis is a circularly polarized light;
part of a light ray other than the light ray on the optical axis is an elliptically polarized light with an ellipticity of less than 1; and
an angle formed by a long axis of an ellipse and a circumferential direction of a circle centered on the light axis in each elliptically polarized light is less than ±45 degrees.
